(19) United States
(12) Patent Application Publication
(10) Pub. No.: US 2017/0019833 A1
(43) Pub. Date: Jan. 19, 2017

(54) METHODS AND DEVICES FOR SENDING OR RECEIVING ROUTING INFORMATION, AND SYSTEM FOR PROCESSING ROUTING INFORMATION

(71) Applicant: ZTE Corporation, Shenzhen (CN)

(72) Inventors: Yumin LUO, Shenzhen (CN); Lin CHEN, Shenzhen (CN); Feng XIE, Shenzhen (CN); Shuyu MA, Shenzhen (CN); Ying HUANG, Shenzhen (CN); Dapeng LI, Shenzhen (CN)

(73) Assignee: ZTE Corporation, Shenzhen (CN)

(21) Appl. No.: 15/106,128

(22) PCT Filed: Jul. 14, 2014
(86) PCT No.: PCT/CN2014/082166

§ 371 Date: Jun. 17, 2016

(30) Foreign Application Priority Data
Dec. 17, 2013 (CN) 201310695618.X

(51) Int. Cl. H04W 40/24; H04W 40/02; H04W 76/04; H04W 76/02

(52) U.S. Cl. CPC H04W 40/248; H04W 76/023; H04W 40/02; H04W 76/048

(57) ABSTRACT

Provided are methods and devices for sending or receiving routing information and a system for processing routing information. The method for sending routing information includes that: a Device-to-Device (D2D) communication management entity sends, to User Equipment (UE), routing information used for D2D communication. The problem that there is no solution applicable to relay communication of D2D UE with other D2D UE in a routing information manner in the related technology is solved, and a solution to communication between the D2D UE based on the routing information is further provided.

### TECHNICAL FIELD

The present disclosure relates to the field of communication, and in particular to methods and devices for sending or receiving routing information, and a system for processing routing information.

### BACKGROUND

In the field of wireless communication, along with rapid development of intelligent terminals and mobile Internet applications, people's requirements on user experience, high rate and large data volume increasingly grow. A conventional cellular network employing an Evolved Node B (eNB) as a data transmission node centre has obvious limitations in terms of support to high data rate and Proximity Service (ProSe). In order to meet such requirements, a Device-to-Device (D2D) technology representative of a new direction of future development of communication technologies emerges. Application of a D2D technology can reduce a burden of a cellular network, reduce battery power consumption of User Equipment (UE), increase data rate, improve robustness of a network infrastructure and well meet requirements on a high-data rate service and ProSe.

A D2D technology may work in an authorized frequency band or an unauthorized frequency band, and allows direct discovery/direct communication of multiple pieces of D2D UE no matter whether a network infrastructure (for example, an eNB) exists. There are mainly three D2D application scenarios as follows:

1) as shown in mode 1 in FIG. 1, UE1 and UE2 perform data interaction under coverage of a cellular network, and user plane data (for example, D2D data) does not pass through a network infrastructure; such an application scenario is usually called an inside-network coverage scenario;

2) as shown in mode 2 in FIG. 1, UE in a weakly-covered/uncovered area performs relay transmission, and UE4 with poorer signal quality is allowed to communicate with the network through nearby UE3 covered by the network, which can help an operating company to extend the coverage and improve capacity; such an application scenario is usually called a network coverage extended scenario; 3) as shown in mode 3 in FIG. 1, direct communication among equipment is allowed under a condition that the cellular network cannot work normally in case of an earthquake or emergency, and one-hop or multi-hop data communication can be performed in a control plane and user plane among UE5, UE6 and UE7 without passing any network infrastructure; and such an application scenario is usually called a network coverage-free or outside-network coverage scenario.

A D2D technology usually includes a D2D discovery technology and a D2D communication technology.

The D2D discovery technology refers to a technology configured to judge/determine proximity between two or more pieces of D2D UE (for example, within a range where D2D direct communication is allowed) or configured to judge/determine that first UE is in proximity to second UE. D2D UE can usually discover each other by sending or receiving discovery signals/information, and under coverage of a cellular network, the network can assist the D2D UE in D2D discovery.

The D2D communication technology refers to a technology configured to implement direct communication of a part or all of communication data between D2D UE without a network infrastructure. Different D2D UE can form a communication group, and performs mutual communication in the D2D communication group; while D2D UE which is not in the communication group cannot receive information sent by UE in the D2D communication group.

In D2D communication, a simplest condition is routing for direct communication between two pieces of D2D UE. When direct communication cannot be performed in a range where two pieces of D2D UE are located, information needs to be forwarded and transmitted through other D2D UE or another network infrastructure to implement communication. In order to enable D2D UE to implement communication with other D2D UE in a D2D communication group (including direct communication, group communication, broadcast communication and the like between the D2D UE) by adopting a D2D direct communication manner or adopting a manner of combining D2D communication and cellular communication, it is necessary to establish a communication route between the D2D UE, and this process may involve the D2D UE and cellular network equipment on a service transmission path, a routing manner, the number of routing hops and the like. However, there is no solution applicable to allocation of routing information under a condition that D2D UE communicates with other D2D UE through the relay in a related technology.

For the problem that there is no solution applicable to relay communication of D2D UE with other D2D UE in a routing information manner in the related technology, there is yet no effective solution.

### SUMMARY

The embodiments of the present disclosure provide methods and devices for sending or receiving routing information, and a system for processing routing information, so as to at least solve the problem.

According to one aspect of the embodiments of the present disclosure, a method for sending routing information is provided, which may include that: a D2D communication management entity sends, to UE, routing information used for D2D communication.

In an exemplary embodiment, before the step that the D2D communication management entity sends the routing information to the UE, the method may further include that: the D2D communication management entity generates the routing information according to state information of the UE, wherein the state information may be used for indicating a neighbouring relationship and/or link condition information between the UE and neighbouring UE.

In an exemplary embodiment, the UE may include: UE under network coverage of an eNB and/or UE outside of network coverage.

In an exemplary embodiment, the UE may include relay UE, wherein the relay UE may be determined by the D2D communication management entity according to a capability of the UE and a position of the UE in a network topology connection relationship, and/or, may be determined by information configured before communication; the relay UE may be divided into following types: a first type of relay UE which is UE located on an edge in the network coverage and responsible for transmitting information in the network coverage to UE outside of network coverage, the information including control information and/or data information; and a second type of relay UE which is UE responsible for forwarding information when all UE is outside of network coverage, the information including control information and/or data information.

In an exemplary embodiment, the D2D communication management entity may include one of: an eNB, a Mobility Management Entity (MME), a ProSe server, a central control node, a group master in a D2D communication group and a cluster head.

In an exemplary embodiment, under a condition that the UE under network coverage forwards data through an eNB, after the step that the D2D communication management entity generates the routing information, the method may further include that: the D2D communication management entity sends the routing information to the eNB.

In an exemplary embodiment, the method may further include that: the D2D communication management entity updates the routing information after receiving at least one of following updating information: updating information, sent by the UE, about change of UE information; updating information, sent by the UE, about change of a neighbouring relationship and/or link state information between UE; updating information, sent by an Evolved Packet Core (EPC), about change of the neighbouring relationship between the UE; updating information, sent by an eNB, about change of an air interface resource; and updating information, sent by a Core Network (CN) where an eNB is located, about change of a backhaul resource load.

In an exemplary embodiment, the updating information may be sent to the D2D communication management entity in an incremental manner or a complete manner.

In an exemplary embodiment, the updating information may be periodically reported by at least one of the UE, the eNB and a location server of the EPC, and/or, may be reported according to an indication of the D2D communication management entity.

In an exemplary embodiment, under a condition that the UE is under network coverage and/or partially under the network coverage, the method may further include that: the D2D communication management entity updates the routing information according to a routing strategy, wherein the routing strategy may include at least one of: cellular network communication preferred, D2D communication preferred and path condition sensing.

In an exemplary embodiment, under a condition that all UE is outside of network coverage, the method may further include that: the D2D communication management entity updates the routing information according to a routing strategy, wherein the routing strategy may include: path condition sensing.

In an exemplary embodiment, the routing information may include: an Identity (ID) of a sending node of the UE and an ID of a next-hop node, wherein the next-hop node may include UE and/or an eNB, the ID of the sending node of the UE may include: a UE ID, the ID of the next-hop node may include: a UE ID and/or an eNB ID, and a current node may be a node to which the routing information is allocated; the UE ID may include: a mobile user ID, an Internet Protocol (IP) address, a logical username, a Temporary Mobile Subscriber Identity (TMSI), an International Mobile Subscriber Identity (IMSI), a Radio Network Temporary Identity (RNTI), or other ID used for UE identification; and the eNB ID may include: a global eNB ID, a logical eNB name and/or an eNB label.

In an exemplary embodiment, the routing information may further include at least one of: network coverage condition information of the sending node of the UE and a communication mode between the sending node of the UE and the next-hop node.

In an exemplary embodiment, before the step that the D2D communication management entity generates the routing information, the method may further include that: the D2D communication management entity receives the state information sent by the UE in one of following manners:

under a condition that the D2D communication management entity is an eNB, UE under network coverage sends the state information to the D2D communication management entity, and/or, the state information sent by UE outside of network coverage is forwarded to the D2D communication management entity through a first type of UE, which is under the network coverage, in the UE;

under a condition that the D2D communication management entity is an MME or a ProSe server, an eNB sends the state information sent by UE under network coverage to the D2D communication management entity, and/or, the eNB and a first type of relay UE, which is under the network coverage, in the UE forward the state information sent by UE outside of network coverage to the D2D communication management entity; and

under a condition that all UE is outside of network coverage, UE directly neighbouring to the D2D communication management entity among the UE sends the state information to the D2D communication management entity, and/or, a second type of relay UE among the UE forwards, to the D2D communication management entity, the state information sent by UE which is not directly neighbouring to the D2D communication management entity.

In an exemplary embodiment, before the step that the D2D communication management entity generates the routing information, the method may include that: the D2D communication management entity receives the state information of the UE from an EPC.

In an exemplary embodiment, before the step that the D2D communication management entity generates the routing information, the method may further include that: the D2D communication management entity acquires information of multiple eNBs and state information of UE related to each eNB in the multiple eNBs, wherein the information of the multiple eNBs may include: information of the multiple eNBs and their neighbouring eNBs and information of UE under network coverage of each eNB; the UE related to each eNB in the multiple eNBs may include: the UE under the network coverage of each eNB, UE which is outside of network coverage but is reachable through forwarding of a first type of relay UE under the network coverage of each eNB; wherein the D2D communication management entity generates the routing information according to the state information of the UE and the information of the multiple eNBs.

In an exemplary embodiment, under a condition that the D2D communication management entity is an MME, one eNB in the multiple eNBs or a ProSe server, the step that the D2D communication management entity acquires the state information of the UE and the information of the multiple eNBs may include that: the D2D communication management entity acquires the state information of each UE and the information of multiple eNBs through the multiple eNBs, wherein each eNB in the multiple eNBs receives the state information of the UE under respective network coverage, and/or, receives the state information, forwarded through the relay UE, of the UE outside of network coverage through the first type of relay UE within respective network coverage, and each eNB in the multiple eNBs sends the state information of each UE and the information of the multiple eNBs to the D2D communication management entity; and under a condition that the D2D communication management entity is one eNB in the multiple eNBs, the eNB serving as the D2D communication management entity receives the state information of the UE related to each eNB and the information of the other eNBs through X2 interfaces with the other eNBs in the multiple eNBs and/or an S1 interface between the eNB and a CN.

In an exemplary embodiment, under a condition that the UE forwards data through an eNB, the step that the D2D communication management entity generates the routing information may include that: a network topology connection relationship between the UE and the eNB is established according to the state information of the UE and information of the eNB; and the routing information is generated according to the network topology connection relationship.

In an exemplary embodiment, under a condition that all UE is outside of network coverage and/or eNBs do not participate in data forwarding, the step that the D2D communication management entity generates the routing information may include that: a network topology connection relationship among multiple pieces of UE is established according to the state information of the multiple pieces of UE; and the routing information is generated according to the network topology connection relationship.

In an exemplary embodiment, the state information of the UE may be determined according to at least one of: feedback of the other UE about receiving conditions of discovery signals sent by the UE to the other UE in the UE, signals received by the UE from the other UE, and position information, acquired from the location server of the EPC, of the UE.

In an exemplary embodiment, under a condition that the UE forwards data through an eNB, the method may further include that: the D2D communication management entity sends the routing information to the eNB.

In an exemplary embodiment, a manner for the D2D communication management entity to send the routing information to the UE and/or the eNB may include one of manners as follows:

under a condition that the D2D communication management entity is an eNB, the D2D communication management entity sends the routing information to UE under the network coverage and/or the eNB, and UE outside of network coverage acquires the routing information by forwarding of a first type of relay UE under the network coverage;

under a condition that the D2D communication management entity is an MME or a ProSe server, the D2D communication management entity sends the routing information to a serving eNB of the UE, then the serving eNB of the UE sends the routing information to the UE, and furthermore, a first type of relay UE in the UE forwards the routing information to UE outside of the network coverage; and under a condition that all UE is outside of network coverage, the D2D communication management entity sends the routing information to UE directly neighbouring to the D2D communication management entity, and/or, the D2D communication management entity sends the routing information to the UE which is not directly neighbouring to the D2D communication management entity through a second type of relay UE in the UE.

In an exemplary embodiment, the D2D communication management entity may generate or update the routing information according to a request of the UE and/or eNB, and/or, the D2D communication management entity may actively generate or update the routing information.

In an exemplary embodiment, the D2D communication management entity may send the updated routing information to the UE and/or the eNB in an incremental notification manner or a complete notification manner.

In an exemplary embodiment, under a condition that one piece of UE in the UE initiates D2D communication according to the received routing information, the method may further include that: the D2D communication management entity receives a traffic starting indication sent by the UE initiating the D2D communication; and routing information of a relay node related to D2D communication of the UE initiating the D2D communication is updated according to the traffic starting indication, wherein the relay node may include: relay UE in the UE and/or the eNB.

In an exemplary embodiment, the traffic starting indication may include: an address of a destination node of traffic; or, the traffic starting indication may include: the address of the destination node of the traffic and a duration of the traffic.

In an exemplary embodiment, after the step that the routing information of the relay node is updated, the method may further include that: the D2D communication management entity receives a traffic ending indication sent by the UE initiating the D2D communication; and the D2D communication management entity stops sending the updated routing information to the relay node related to the D2D communication according to the traffic ending indication.

In an exemplary embodiment, under a condition that one piece of UE in the UE needs to forward data through an eNB, after the eNB receives the data, the method may further include that: the eNB judges whether UE receiving the data is in a Discontinuous Reception (DRX) state or not; and under a condition that a judgment result is that the UE receiving the data is in the DRX state, the eNB forwards a data packet to the UE receiving the data within a next on duration/active time of the UE receiving the data.

In an exemplary embodiment, under a condition that at least one piece of UE in the UE sends a data packet to UE served by an eNB through the eNB, the method may further include that: the eNB judges whether there is UE in a DRX state among all UE under network coverage of the eNB or not; under a condition that a judgment result is that there is UE in the DRX state, the eNB sends a group communication prenotice through a Physical Downlink Control Channel (PDCCH) within an on duration/active time of the UE in the DRX state; and under a condition that all UE served by the eNB enters a continuous reception state, the eNB sends the data packet to the UE served by the eNB by group communication.

In an exemplary embodiment, the eNB may configure the same DRX parameter to the UE under the network coverage of the eNB.

According to another aspect of the present disclosure, a method for receiving routing information is further provided, which may include that: D2D UE receives, from a D2D communication management entity, routing information used for D2D communication.

In an exemplary embodiment, before the step that the UE receives the routing information, the method may further include that: the D2D communication management entity acquires state information of the UE from the UE and/or a location server of an EPC, wherein the state information may be used for indicating a neighbouring relationship and/or link condition information between the UE and neighbouring UE, and the routing information may be generated by the D2D communication management entity according to the state information.

In an exemplary embodiment, after the step that the UE receives the routing information, the method may further include that: the UE performs D2D communication according to the routing information, wherein UE initiating communication judges whether D2D communication is able to be performed with corresponding UE or not according to the received routing information, and under a condition that a judgment result is that the D2D communication is able to be performed with the corresponding UE, the UE initiating communication initiates D2D communication to the corresponding UE, wherein the D2D communication may include one of manners as follows: unicast communication, group communication and broadcast communication.

In an exemplary embodiment, under a condition that the UE performs D2D communication according to the routing information and an address of a destination node of a data packet received by a first type of relay UE or a second type of relay UE in the UE is not an address of the first type of relay UE or the second type of relay UE, the first type of relay UE or the second type of relay UE may forward the data packet according to an ID of a next-hop node and/or a communication mode between the first type of relay UE or the second type of relay UE and the next-hop node in the routing information.

In an exemplary embodiment, the communication mode may be contained in the routing information, or, may be determined according to the ID of the next-hop node, wherein a D2D communication manner is adopted when the next-hop node is UE, and a cellular communication manner is adopted when the next-hop node is an eNB.

In an exemplary embodiment, under a condition that the number of pieces of UE neighbouring to the first type of relay UE or the second type of relay UE in the UE is more than or equal to 2, after the step that the first type of relay UE or the second type of relay UE receives the routing information from the D2D communication management entity, the method may include that: the first type of relay UE or the second type of relay UE receives D2D communication forwarding table information sent by the D2D communication management entity, wherein the D2D communication forwarding table information may be used for indicating processing of the first type of relay UE or the second type of relay UE over the received data packet in group communication and/or broadcast communication.

In an exemplary embodiment, under a condition that the first type of relay UE or the second type of relay UE is not directly neighbouring to the D2D communication management entity, the first type of relay UE or the second type of relay UE receives the D2D communication forwarding table information through UE directly neighbouring to the D2D communication management entity and/or an eNB.

In an exemplary embodiment, the D2D communication forwarding table information may include: a D2D communication address, a communication mode and a latest data packet index.

In an exemplary embodiment, the D2D communication forwarding table information may be generated by the D2D communication management entity according to a preset strategy, wherein the preset strategy may include at least one of: cellular communication preferred, D2D communication preferred and path condition sensing.

In an exemplary embodiment, the D2D communication forwarding table information generated according to the preset strategy of cellular communication preferred may include: D2D communication forwarding table information used for local routing of an eNB, and/or, D2D communication forwarding table information used for routing through a CN.

In an exemplary embodiment, under a condition that the D2D communication forwarding table information includes the D2D communication forwarding table information used for local routing of the eNB and the D2D communication forwarding table information used for routing through the CN, before group communication and/or broadcast communication of the first type of relay UE or the second type of relay UE, the method may further include that: the first type of relay UE or the second type of relay UE determines D2D communication forwarding table information used for group communication and/or broadcast communication according to path weights of the D2D communication forwarding table information used for local routing of the eNB and the D2D communication forwarding table information used for routing through the CN.

In an exemplary embodiment, after the first type of relay UE or the second type of relay UE receives the D2D communication forwarding table information, the step that the first type of relay UE or the second type of relay UE processes the received data packet according to the D2D communication forwarding table information may include that: the first type of relay UE or the second type of relay UE judges whether the received data packet is consistent with a preset characteristic or not, wherein the preset characteristic may include that: an address of the destination node of the data packet is a group communication/broadcast communication address, and an index of the data packet is a latest data packet index in the D2D communication forwarding table information or the index of the data packet has yet not appeared in the D2D communication forwarding table information; under a condition that a judgment result indicates that the data packet is consistent with the preset characteristic, the received data packet is analyzed; and the received data packet is forwarded according to a communication mode, indicated in the D2D communication forwarding table, between the first type of relay UE or the second type of relay UE and the destination node.

In an exemplary embodiment, under a condition that the judgment result indicates that the data packet is inconsistent with the preset characteristic, the step that the first type of relay UE or the second type of relay UE processes the received data packet according to the D2D communication forwarding table information may further include that: the first type of relay UE or the second type of relay UE discards the received data packet.

In an exemplary embodiment, after the step that the first type of relay UE or the second type of relay UE forwards the received data packet, the method may further include that: the first type of relay UE or the second type of relay UE updates the data packet index in the D2D communication forwarding table information.

In an exemplary embodiment, under a condition that a UE communication node topology relationship changes, the method may further include that: the first type of relay UE or the second type of relay UE receives updating information of the D2D communication forwarding table information from the D2D communication management entity.

In an exemplary embodiment, change of the UE communication node topology relationship may include at least one of: disappearance of a UE communication node and addition of a UE communication node.

In an exemplary embodiment, the routing information may be sent by the D2D communication management entity according to a request of the UE, and/or, the routing information may be actively sent by the D2D communication management entity.

According to another aspect of the embodiments of the present disclosure, a device for sending routing information is further provided, which may be located in a D2D communication management entity, including: a first sending component, configured to send, to UE, routing information used for D2D communication.

According to another aspect of the embodiments of the present disclosure, a device for receiving routing information is further provided, which may be located in UE supporting D2D communication, including: a receiving component, configured to receive, from a D2D communication management entity, routing information used for D2D communication.

According to another aspect of the embodiments of the present disclosure, a system for processing routing information is further provided, which may include: the abovementioned D2D communication management entity and the abovementioned UE.

According to the embodiments of the present disclosure, a manner that the D2D communication management entity sends the routing information used for D2D communication to the UE is adopted, so that the problem that there is no solution applicable to relay communication of D2D UE with other D2D UE in a routing information manner in the related technology is solved, and a solution to communication between the D2D UE based on the routing information is further provided.

### BRIEF DESCRIPTION OF THE DRAWINGS

The drawings described here are adopted to provide further understanding of the present disclosure, and form a part of the present disclosure. Schematic embodiments of the present disclosure and description thereof are adopted to explain the present disclosure and not intended to form improper limits to the present disclosure. In the drawings:

FIG. 1 is a diagram of a D2D application scenario according to the related technology;

FIG. 2 is a preferred flowchart of a method for sending routing information according to an embodiment of the present disclosure;

FIG. 3 is a preferred flowchart of a method for receiving routing information according to an embodiment of the present disclosure;

FIG. 4 is a preferred structure diagram of a device for sending routing information according to an embodiment of the present disclosure;

FIG. 5 is a preferred structure diagram of a device for receiving routing information according to an embodiment of the present disclosure;

FIG. 6 is a flowchart of neighbouring relationship detection and acquisition of D2D UE according to a preferred embodiment of the present disclosure;

FIG. 7 is a flowchart of communication routing table information establishment of a D2D communication management entity in inside-network coverage and network coverage extended scenarios according to a preferred embodiment of the present disclosure;

FIG. 8 is a diagram of a communication routing table information establishment process in a network coverage extended scenario according to a preferred embodiment of the present disclosure;

FIG. 9 is a diagram of a cross-eNB communication routing table information establishment process in a D2D communication scenario according to a preferred embodiment of the present disclosure;

FIG. 10 is a diagram of a process of updating routing information after a neighbouring relationship between D2D UE changes according to a preferred embodiment of the present disclosure;

FIG. 11 is a diagram of a process of establishing and managing communication routing information when D2D UE is all outside of network coverage according to a preferred embodiment of the present disclosure;

FIG. 12 is a diagram of a process of performing communication between D2D UE according to routing information according to a preferred embodiment of the present disclosure;

FIG. 13a and FIG. 13b are diagrams of processes of generating routing information for group communication of D2D UE in a D2D communication group according to a preferred embodiment of the present disclosure;

FIG. 14 is a diagram of a traffic indication control process in a communication process according to a preferred embodiment of the present disclosure; and

FIG. 15 is a diagram of a process of DRX coordination of a communication process in inside-network coverage and network coverage extended scenarios according to a preferred embodiment of the present disclosure.

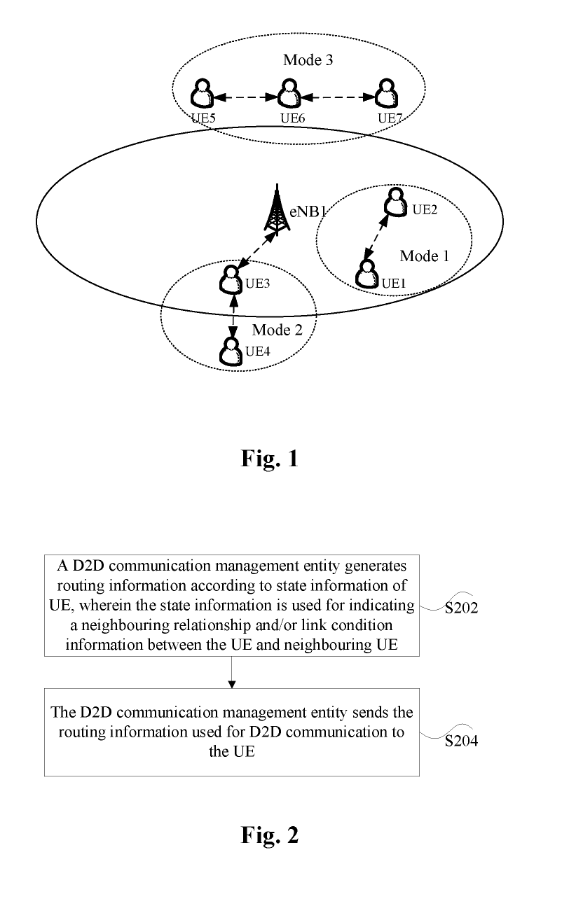

### DETAILED DESCRIPTION OF THE EMBODIMENTS

It is important to note that embodiments in the present disclosure and characteristics in the embodiments may be combined under a condition of no conflicts. The present disclosure will be described below with reference to the drawings and the embodiments in detail.

Steps shown in flowcharts of the drawings may be executed in a computer system, such as a group of computers, capable of executing instructions, and moreover, although logic sequences are shown in the flowcharts, the shown or described steps may be executed in sequences different from those described here under certain circumstances.

The embodiment provides a method for sending routing information, which includes the following step:

Step S204: a D2D communication management entity sends routing information used for D2D communication to UE.

UE supporting D2D communication described in the embodiment of the present disclosure is also called D2D UE and ProSe UE, and may be called UE for short hereinafter.

By the step, after the D2D communication management entity sends the routing information to the D2D UE, the D2D UE may support more complicated D2D communication, and for example, in some embodiments, the D2D UE sends a data packet to other D2D UE which is not adjacent to the D2D UE and may not be detected according to the routing information. By the step, the problem that there is no solution applicable to relay communication of D2D UE with other D2D UE in a routing information manner in the related technology is solved.

In an exemplary embodiment, the D2D communication management entity sends the routing information to all related D2D UE, and under a condition that the D2D UE needs to send a data packet to the other UE, the D2D UE judges whether communication with corresponding UE is reachable or not according to the received routing information, sends the data packet in a specified manner to the neighbouring D2D UE according to the routing information after determining that the communication is reachable, and under a condition that communication is unreachable, may not send the data packet, thereby avoiding waste of a communication resource.

In an exemplary embodiment, relay UE and/or an eNB determine(s) forwarding of the data packet and a data packet forwarding manner according to the routing information sent by the D2D communication management entity and the reaching data packet.

In an exemplary embodiment, the routing information may be configured according to preset configuration information. For example, an operating company configures D2D UE to a preset node position according to an application of the D2D UE, and updates configuration information to reconfigure routing information according to information reported by the D2D UE.

Preferably, in the embodiment, a manner that the D2D communication management entity generates the routing information according to state information of the UE is adopted, wherein the state information is used for indicating a neighbouring relationship and/or link condition information between the UE and neighbouring UE. The link condition information includes a link condition, for example, signal strength, between the UE and the neighbouring UE. In some preferred implementation modes, the neighbouring relationship between the UE and the neighbouring UE may be determined according to the link condition information of the UE and the neighbouring UE.

FIG. 2 is a preferred flowchart of a method for sending routing information according to an embodiment of the present disclosure, and as shown in FIG. 2, the flow preferably includes the following steps:

Step S202: a D2D communication management entity generates routing information according to state information of UE, wherein the state information is used for indicating a neighbouring relationship and/or link condition information between the UE and neighbouring UE; and

Step S204: the D2D communication management entity sends the routing information used for D2D communication to the UE.

In an exemplary embodiment, the UE may be: all located under network coverage of an eNB, or all located outside of network coverage, or a part of the UE may be located under the network coverage of the eNB, and the other part is located outside of network coverage. In an exemplary embodiment, the UE outside of network coverage is at least neighbouring to one piece of the UE under the network coverage, or the UE outside of network coverage may communicate with relay UE under the network coverage through one or more pieces of relay UE outside of network coverage.

In addition, the UE under the network coverage of the eNB and the UE, which requires data forwarding of the relay UE under the network coverage of the eNB, outside of network coverage are called UE related to the eNB in the present disclosure.

The eNB includes various macro eNBs and micro eNBs, including: eNBs in a second-generation communication network and NodeBs or eNBs in a third-generation communication system.

In an exemplary embodiment, the UE includes relay UE and/or ordinary UE, wherein the relay UE is also called UE with an enabled relay function and configured to relay data (for example, D2D data) of multiple pieces of UE. The relay UE is determined by the D2D communication management entity according to a capability of the UE and a position of the UE in a network topology connection relationship, and/or, is determined by information configured before communication. For example, the D2D communication management entity may determine whether UE is relay UE or not according to state information of the UE, and for example, when first UE is not neighbouring to second UE, UE neighbouring to the first UE and the second UE is determined as relay UE; or, when the first UE is outside of network coverage, UE which is neighbouring to the first UE and under the network coverage is determined as relay UE. The relay UE may be divided into following types: a first type of relay UE which is UE located on an edge in the network coverage and responsible for transmitting information in the network coverage to UE outside of network coverage, the information including control information and/or data information; and a second type of relay UE which is UE responsible for forwarding information when all UE is outside of network coverage, the information including control information and/or data information.

In an exemplary embodiment, according to different application scenarios and requirements of system designs, the D2D communication management entity may be arranged in multiple kinds of existing equipment, or multiple kinds of existing equipment may be determined as the D2D communication management entity. It is important to note that the D2D communication management entity is configured to describe a function of the entity, and it may be a component in corresponding equipment, or a new function entity obtained after modifying a component in the corresponding equipment in a hardware or software level, or a new function entity.

In an exemplary embodiment, the D2D communication management entity includes one of: an eNB, an MME, a ProSe server, a central control node formed by multiple pieces of UE according to geographical positions and UE serving as a cluster head (or called a group master or group master) in a communication group formed by multiple pieces of UE.

In an exemplary embodiment, under a condition that the UE needs to forward data through the eNB, after Step S202, the D2D communication management entity sends the routing information to the eNB, thereby enabling the eNB to forward data between the UE under the network coverage according to the routing information. The UE under the network coverage may be located under network coverage of the same eNB, and may also be located under network coverage of different eNBs, and then different eNBs implement forwarding of the data between the UE under the network coverage; and correspondingly, the D2D communication management entity sends the routing information to different eNBs respectively.

In an exemplary embodiment, after Step S202, the method further includes that: the D2D communication entity acquires at least one of following updating information and updates the routing information according to the received updating information: updating information, sent by the D2D UE, about change of UE information; updating information, sent by the D2D UE, about change of a neighbouring relationship and/or link state information between UE; updating information, acquired by an EPC through the location server, about change of the neighbouring relationship between the UE; updating information, sent by an eNB, about change of an air interface resource; and updating information, sent by a CN where an eNB is located, about change of a backhaul resource load.

In an exemplary embodiment, the corresponding information which changes is sent to the D2D communication management entity through the updating information in a change manner or a complete manner, wherein the change manner refers to containing change of the corresponding information in the updating information, or only containing a result of the corresponding information which changes; and the completely new manner refers to containing the whole updated routing information in the updating information in a manner of whole table.

In an exemplary embodiment, the updating information is periodically reported by at least one of the UE and/or the eNB and/or the location server of the EPC, and/or, is reported by at least one piece of UE and/or the eNB and/or the location server of the EPC according to an indication of the D2D communication management entity, and/or, the UE or the eNB or the location server of the EPC is triggered to report the updating information under a condition that the corresponding information changes or the change reaches a certain threshold value.

In an exemplary embodiment, under a condition that the UE is under network coverage and/or partially under the network coverage, namely in an inside-network coverage scenario or a network coverage extended scenario, the D2D communication management entity may further update the generated routing information according to a routing strategy, wherein the routing strategy includes, but not limited to, at least one of: cellular network communication preferred, D2D communication preferred and path condition sensing.

In an exemplary embodiment, under a condition that all UE is outside of network coverage, namely in an outside-network coverage scenario, the method further includes that: the D2D communication management entity may further update the generated routing information according to a routing strategy, wherein the routing strategy includes: path condition sensing.

In an exemplary embodiment, under a condition that the D2D UE is all under the network coverage, namely in an inside-network coverage scenario, the routing information may be: an ID of a sending node of the UE and an ID of a next-hop node, and the routing information may optionally include network coverage condition information of the UE and/or a communication mode between the node and the next-hop node, wherein the next-hop node includes: UE and/or an eNB. In an exemplary embodiment, the ID of the sending node of the UE includes: a UE ID, and the ID of the next-hop node includes: a UE ID and/or an eNB ID; the UE ID may include: a mobile user ID, an IP address, a logical username, a TMSI, an IMSI, an RNTI, or other ID used for UE identification; and the eNB ID includes: a global eNB ID, a logical eNB name and/or an eNB label.

In an exemplary embodiment, under a condition that the UE includes the UE under the network coverage and the UE outside of network coverage, namely in the network coverage extended scenario, the routing information may further be: an ID of a sending node of the UE, an ID of a next-hop node and optional network coverage condition information of the D2D UE and communication mode between the sending node of the UE and the next-hop node, wherein the next-hop node includes UE and/or an eNB. Network position information of the UE is configured to indicate whether the UE is located under the network coverage or not, and may also be configured to indicate the eNB under network coverage where the UE is located.

In an exemplary embodiment, under a condition that the D2D UE is all located outside of network coverage, the routing information may be: an ID of a sending node of the UE and an ID of a next-hop node, wherein the next-hop node includes: UE.

In an exemplary embodiment, the ID of the sending node of the UE in the routing information usually does not include the node ID of the sending node of the UE.

In an exemplary embodiment, before Step S202, the D2D communication management entity acquires the state information of the D2D UE in one of manners as follows:

1: under a condition that the D2D communication management entity is an eNB, UE under network coverage sends the state information to the D2D communication management entity, and/or, the state information sent by UE outside of network coverage is forwarded to the D2D communication management entity through a first type of UE, which is under the network coverage, in the UE. For example, the first type of relay UE forwards the state information of the UE outside of network coverage to the eNB which serves as the D2D communication management entity. Under a condition that the first type of relay UE is not located under network coverage of the D2D communication management entity, the first type of relay UE forwards the state information through an eNB neighbouring to the eNB which serves as the D2D communication management entity.

2: under a condition that the D2D communication management entity is a ProSe server or an MME and the D2D UE includes the UE under the network coverage (for example, the UE is all located under the network coverage, or a part of the UE is located under the network coverage), an eNB sends the state information sent by the UE under the network coverage to the D2D communication management entity, and/or, the eNB and a first type of relay UE in the UE forward the state information sent by UE outside of network coverage to the D2D communication management entity. In brief, for 1, the ProSe server or the MME acquires the state information of the UE through the eNB.

3: under a condition that all UE is outside of network coverage, the D2D communication management entity may be one or more pieces of UE in the related UE, and then UE directly neighbouring to the UE serving as the D2D communication management entity in the related UE sends the state information to the D2D communication management entity, and/or, a second type of relay UE in the related UE forwards the state information sent by UE which is not directly neighbouring to the UE serving as the D2D communication management entity to the D2D communication management entity.

4: under a condition that the D2D UE is all located under the network coverage, the D2D communication management entity may acquire the state information of the UE through the location server of the EPC.

In an exemplary embodiment, under a condition that the UE under the network coverage is located under network coverage of multiple eNBs respectively, before Step S202, the D2D communication management entity acquires the state information of the related UE and information of the multiple eNBs. The information of the multiple eNBs include: information of the multiple eNBs and their neighbouring eNBs and information of the UE under the network coverage of each eNB, for example, node IDs of the eNBs and information of the UE under the network coverage of the eNBs and their neighbouring eNBs. Step S202 includes that: the D2D communication management entity generates the routing information according to the state information of the related UE and the information of the multiple eNBs.

In an exemplary embodiment, the D2D communication management entity acquires the state information of each piece of UE in the related UE and the information of the multiple eNBs through the multiple eNBs, wherein each eNB in the multiple eNBs acquires the state information of the UE under respective network coverage, and/or, the D2D communication management entity acquires the state information of the UE outside of network coverage through the first type of relay UE within its own network coverage.

In an exemplary embodiment, under a condition that the D2D communication management entity is one of an MME, one eNB in the multiple eNBs and a ProSe server, the D2D communication management entity acquires the state information of the D2D UE and the information of the multiple eNBs through the multiple eNBs respectively, wherein each eNB in the multiple eNBs acquires the state information of the UE under respective network coverage, and/or, the D2D communication management entity acquires the state information, which may be forwarded through the first type of relay UE, of the UE outside of network coverage through the first type of relay UE within its own network coverage, and each eNB in the multiple eNBs sends the state information of each UE and the information of the multiple eNBs to the D2D communication management entity.

In an exemplary embodiment, under a condition that the D2D communication management entity is one eNB in the multiple eNBs, the eNB serving as the D2D communication management entity acquires the state information of the UE in the D2D UE related to the other eNBs and the information of the other eNBs through X2 interfaces with the other eNBs in the multiple eNBs and/or an S1 interface between the eNB and a CN.

In an exemplary embodiment, under a condition that the D2D communication management entity is a ProSe server or an MME, the D2D communication management entity acquires the state information of the UE related to each eNB and the information of the multiple eNBs through each eNB.

In an exemplary embodiment, under a condition that the UE needs to forward the data through the eNB, Step S202 includes that: a network topology connection relationship between the D2D UE and the eNB is established according to the state information of the D2D UE and information of the eNB; and the routing information is generated according to the network topology connection relationship.

In an exemplary embodiment, under a condition that all UE is outside of network coverage, Step S202 includes that: a network topology connection relationship among D2D UE is established according to the state information of the D2D UE; and the routing information is generated according to the network topology connection relationship.

In an exemplary embodiment, the state information of one piece of UE in the D2D UE is determined according to feedback of the other UE about receiving conditions of discovery signals sent by the UE to the other UE, and/or is determined according to signals received by the UE from the other UE, and/or is determined according to position information, acquired from the location server of the EPC, of the UE.

In an exemplary embodiment, under a condition that the D2D UE needs to forward the data through the eNB, the method further includes that: the D2D communication management entity sends the routing information of the D2D UE to the eNB.

In an exemplary embodiment, a manner for the D2D communication management entity to send the routing information of the D2D UE to the D2D UE and/or the eNB includes one of manners as follows:

1: under a condition that the D2D communication management entity is an eNB, the D2D communication management entity sends the routing information to UE under the network coverage and/or the eNB, and/or, the D2D communication management entity sends the routing information to UE outside of network coverage through a first type of relay UE;

2: under a condition that the D2D communication management entity is an MME or a ProSe server, the D2D communication management entity sends the routing information to a serving eNB of the UE, then the serving eNB of the UE sends the routing information to the UE, and furthermore, a first type of relay UE in the UE forwards the routing information to UE outside of the network coverage; and

3: under a condition that all UE is outside of network coverage, the D2D communication management entity directly sends the routing information to UE directly neighbouring to the D2D communication management entity, and/or, the D2D communication management entity sends the routing information to the UE which is not directly neighbouring to the D2D communication management entity through a second type of relay UE in the UE.

In an exemplary embodiment, the D2D communication management entity generates or updates the routing information according to a request of the UE and/or eNB, and/or, the D2D communication management entity actively generates or updates the routing information.

In an exemplary embodiment, the D2D communication management entity sends the updated routing information to the D2D UE and/or the eNB in a change notification manner or a complete notification manner, wherein the change notification manner refers to notifying that the updated routing information contains change of the routing information, or only contains a result of the corresponding routing information which changes, and the completely new notification manner refers to that the updated routing information contains the whole updated routing information.

In an exemplary embodiment, after the routing information is generated, under a condition that the D2D UE initiates D2D communication, the D2D communication management entity receives a traffic starting indication sent by the UE initiating the D2D communication; and periodic or aperiodic updating of routing information of a relay node related to D2D communication of the UE initiating the D2D communication is started according to the traffic starting indication and a preset strategy, wherein the relay node includes: relay UE and/or the eNB. The relay node related to D2D communication of the UE initiating the D2D communication refers to a relay node through which a path established for D2D communication needs to pass.

In an exemplary embodiment, the traffic starting indication includes: an address of a destination node of traffic, and may optionally include a duration of the traffic.

In an exemplary embodiment, after the routing information of the relay node related to D2D communication of the UE initiating the D2D communication is updated, the D2D communication management entity receives a traffic ending indication sent by the UE initiating the D2D communication; and sending of the updated routing information to the relay node related to the D2D communication is stopped according to the traffic ending indication. For a relay node related to the D2D communication of UE initiating other D2D communication, periodic or aperiodic updating of the routing information is configured according to the preset strategy.

In an exemplary embodiment, under a condition that the D2D UE needs to forward data through an eNB, after the eNB receives a data packet, the eNB judges whether UE to which the data packet is forwarded is in a DRX state or not; and under a condition that a judgment result is that the UE is in the DRX state, the eNB forwards the data packet to the UE within a next on duration/active time of the UE.

In an exemplary embodiment, under a condition that the D2D UE needs to forward data through an eNB, if the eNB determines that it is group communication after receiving a data packet, the eNB judges whether the other UE to which a data packet needs to be forwarded is in a DRX state or not according to the routing information; under a condition that a judgment result indicates that at least one piece of UE in the other UE is in the DRX state, the eNB sends a group communication prenotice to the other UE through a PDCCH within an on duration/active time of the UE in the DRX state, wherein the group communication prenotice is configured to indicate the UE to enter a continuous reception state; and under a condition that all of the other UE enters the continuous reception state, the eNB sends the data packet to the other UE by group communication.

In an exemplary embodiment, the UE located under the network coverage of the same eNB in the D2D UE is configured with the same DRX state parameter.

The embodiment further provides a method for receiving routing information, which includes the following step:

Step S304: D2D UE receives routing information used for D2D communication from a D2D communication management entity.

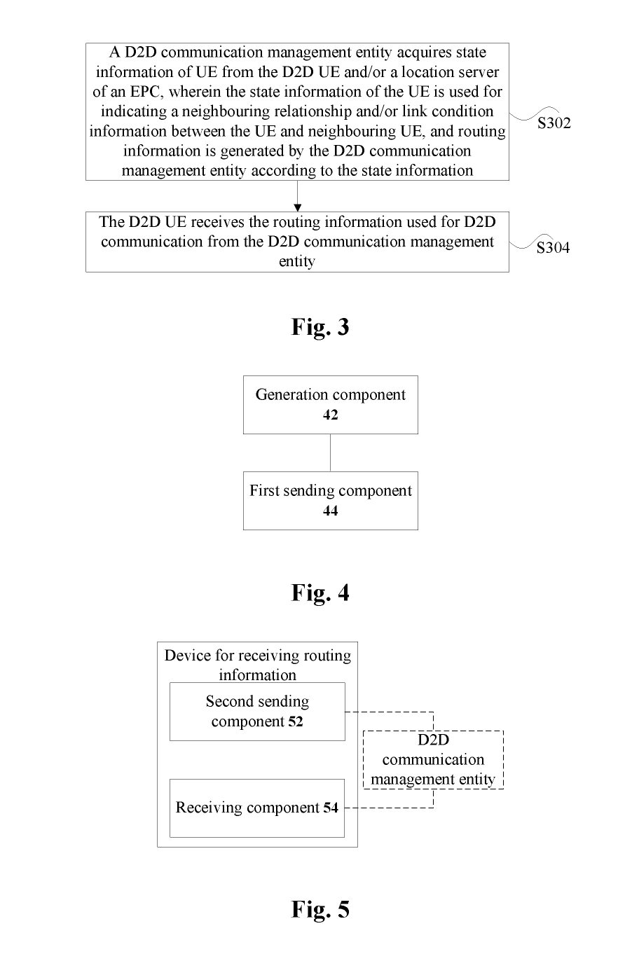

FIG. 3 is a preferred flowchart of a method for receiving routing information according to an embodiment of the present disclosure, and as shown in FIG. 3, the flow preferably includes the following steps:

Step S302: a D2D communication management entity acquires state information of UE from the D2D UE and/or a location server of an EPC, wherein the state information of the UE is used for indicating a neighbouring relationship and/or link condition information between the UE and neighbouring UE, and routing information is generated by the D2D communication management entity according to the state information; and

Step S304: the D2D UE receives the routing information used for D2D communication from the D2D communication management entity.

In an exemplary embodiment, after the D2D UE receives the routing information, the D2D UE performs D2D communication according to the routing information, wherein D2D UE judges whether D2D communication is able to be performed with corresponding UE or not according to the received routing information, and under a condition that a judgment result is that the D2D communication is able to be performed with the corresponding UE, the UE initiates D2D communication to the corresponding UE according to a routing information table entry acquired according to the routing information and an address of a destination node, wherein the D2D communication includes one of manners as follows: unicast communication, group communication and broadcast communication.

In an exemplary embodiment, under a condition that the UE performs D2D communication according to the routing information and an address of a destination node of a data packet received by relay UE in the UE is not an address of the relay UE, the relay UE searches a routing information table for a corresponding table entry to obtain a corresponding next hop according to the address of the destination node, and then the relay UE forwards the data packet according to a communication mode with a next-hop node and an ID of the next-hop node in the routing information, wherein the communication mode is contained in the routing information, or, is determined according to the ID of the next-hop node, a D2D communication manner is adopted when the next-hop node is UE, and a cellular communication manner is adopted when the next-hop node is an eNB.

In an exemplary embodiment, under a condition that the number of pieces of UE neighbouring to the relay UE in the D2D UE is more than or equal to 2, after Step S304, the relay UE receives D2D communication forwarding table information established and sent by the D2D communication management entity, wherein the D2D communication forwarding table information is configured to indicate processing of the relay UE over the received data packet in group communication and/or broadcast communication, and the D2D communication management entity establishes a network topology structure according to the acquired UE information, establishes a minimum spanning tree according to a communication condition of the node, limits forwarding of the relay node, and establishes the D2D communication forwarding table information for UE of which the number of neighbouring UE is more than or equal to 2.

In an exemplary embodiment, under a condition that the relay UE is not neighbouring to the D2D communication management entity, the relay UE receives the D2D communication forwarding table information through UE neighbouring to the D2D communication management entity and/or an eNB.

In an exemplary embodiment, the D2D communication forwarding table information includes: a D2D communication address, a communication mode and a latest data packet index.

In an exemplary embodiment, the D2D communication forwarding table information is generated by the D2D communication management entity according to a preset strategy, wherein the preset strategy includes at least one of: cellular communication preferred, D2D communication preferred and path condition sensing.

In an exemplary embodiment, the D2D communication forwarding table information generated according to the preset strategy of cellular communication preferred includes: D2D communication forwarding table information used for local routing of an eNB, and/or, D2D communication forwarding table information used for routing through a CN.

In an exemplary embodiment, under a condition that the D2D communication forwarding table information includes the D2D communication forwarding table information used for local routing of the eNB and the D2D communication forwarding table information used for routing through the CN, before group communication and/or broadcast communication of the relay UE, the relay UE determines D2D communication forwarding table information used for group communication and/or broadcast communication according to path weights of the D2D communication forwarding table information used for local routing of the eNB and the D2D communication forwarding table information used for routing through the CN.

In an exemplary embodiment, after the relay UE receives the D2D communication forwarding table information, the relay UE processes the received data packet according to the D2D communication forwarding table information.

In an exemplary embodiment, in a processing process, the relay UE judges whether the received data packet is consistent with a preset characteristic or not, wherein the preset characteristic includes that: an address of the destination node of the data packet is a group communication/broadcast communication address, and an index of the data packet is a latest data packet index in the D2D communication forwarding table information or the index of the data packet has yet not appeared in the D2D communication forwarding table information; under a condition that a judgment result indicates that the data packet is consistent with the preset characteristic, the received data packet is analyzed; and the received data packet is forwarded according to a communication mode, indicated in the D2D communication forwarding table, between the relay UE and the destination node.

In an exemplary embodiment, under a condition that the judgment result indicates that the data packet is inconsistent with the preset characteristic, the relay UE discards the received data packet.

In an exemplary embodiment, after the relay UE forwards the received data packet, the relay UE updates the index of the latest received data packet in the D2D communication forwarding table information.

In an exemplary embodiment, under a condition that a UE communication node topology relationship changes, the relay UE receives updating information of the D2D communication forwarding table information from the D2D communication management entity.

In an exemplary embodiment, change of the UE communication node topology relationship includes at least one of: disappearance of a UE communication node and addition of a UE communication node.

In an exemplary embodiment, the routing information is sent by the D2D communication management entity according to a request of at least one piece of UE, and/or, the routing information is actively sent by the D2D communication management entity.

The embodiment further provides a device for sending routing information, which is located in a D2D communication management entity. It is important to note that the device is configured to implement the abovementioned method for sending routing information, a structure, preferred structure and functions of the device embodiment may be directly and undoubtedly determined according to descriptions in the method embodiment, and the preferred structure of the device will not be elaborated in the embodiment.

The device for sending routing information provided by the embodiment includes a first sending component, configured to send routing information used for D2D communication to D2D UE.

FIG. 4 is a preferred structure diagram of a device for sending routing information according to an embodiment of the present disclosure, and as shown in FIG. 4, the device preferably includes: a generation component 42 and a first sending component 44, wherein the generation component 42 is configured to generate routing information according to state information of UE, wherein the state information is used for indicating a neighbouring relationship and/or link condition information between the UE and neighbouring UE; and the first sending component 44 is coupled to the generation component 42, and is configured to send the routing information used for D2D communication to the D2D UE.

The components and units involved in the embodiment of the present disclosure may be implemented in a software manner, and may also be implemented in a hardware manner. The components and units described in the embodiment may also be arranged in a processor, and for example, it may be described that: a processor includes a generation component 42 and a first sending component 44. The names of these components are not intended to limit the components under certain circumstances, and for example, the generation component 42 may also be described as “a component configured to generate routing information according to state information of UE”.

In an exemplary embodiment, the D2D UE includes: UE located under network coverage of an eNB and/or UE outside of network coverage.

In an exemplary embodiment, the UE includes relay UE and/or ordinary UE, wherein the relay UE is determined by a D2D communication management entity according to a capability of the UE and a position of the UE in a network topology connection relationship, and/or, is determined by information configured before communication. The relay UE may be divided into following types: a first type of relay UE which is UE located on an edge in the network coverage and responsible for transmitting information in the network coverage to UE outside of network coverage, the information including control information and/or data information; and a second type of relay UE which is UE responsible for forwarding information when all UE is outside of network coverage, the information including control information and/or data information.

In an exemplary embodiment, the D2D communication management entity includes one of: an eNB, an MME, a ProSe server, a central control node and UE serving as a cluster head (or called a group master or group master) in a D2D communication group.

In an exemplary embodiment, under a condition that the D2D UE needs to forward data through an eNB, the first sending component 44 is further configured to send the routing information to the eNB.

In an exemplary embodiment, the device further includes an updating component 46, coupled to the generation component 42 and configured to acquire at least one of following updating information and update the routing information according to the updating information: updating information, sent by the UE, about change of UE information; updating information, sent by the UE, about change of a neighbouring relationship and/or link state information between UE; updating information, acquired by an EPC through the location server, about change of positions between the UE; updating information, sent by an eNB, about change of an air interface resource; and updating information, sent by a CN where an eNB is located, about change of a backhaul resource load.

In an exemplary embodiment, the updating information is sent to the D2D communication management entity in an incremental manner or a complete manner.

In an exemplary embodiment, the updating information is periodically reported by the D2D UE and/or the eNB and/or the location server of the EPC, and/or, is reported by the D2D UE and/or the eNB and/or the location server of the EPC according to an indication of the D2D communication management entity.

In an exemplary embodiment, under a condition that the D2D UE is located under the network coverage and/or partially located under the network coverage, the updating component 46 is further configured to update the routing information according to a routing strategy, wherein the routing strategy includes at least one of: cellular network communication preferred, D2D communication preferred and path condition sensing.

In an exemplary embodiment, under a condition that the D2D UE is all UE outside of network coverage, the updating component 46 is further configured to update the routing information according to a routing strategy, wherein the routing strategy includes: path condition sensing.

In an exemplary embodiment, under a condition that the D2D UE is all under network coverage, the routing information includes: an ID of a sending node of the UE and an ID of a next-hop node, and the routing information includes or does not include a communication mode between a current node and the next-hop node, wherein the next-hop node includes UE and/or an eNB, the ID of the sending node of the UE includes: a UE ID, and the ID of the next-hop node includes: a UE ID and/or an eNB ID;

wherein, the UE ID includes: a mobile user ID, an IP address, a logical username, a TMSI, an IMSI, an RNTI, or other ID used for UE identification; and the eNB ID includes: a global eNB ID, a logical eNB name and/or an eNB label.

In an exemplary embodiment, under a condition that the D2D UE includes the UE under the network coverage and the UE outside of network coverage, the routing information includes: an ID of a sending node of the UE and an ID of a next-hop node, and the routing information may optionally include network coverage condition information of the UE and a communication mode between the current node and the next-hop node, wherein the next-hop node includes UE and/or an eNB.

In an exemplary embodiment, under a condition that the D2D UE is all located outside of network coverage, the routing information includes: an ID of a sending node of the UE and an ID of a next-hop node, wherein the next-hop node includes: UE.

In an exemplary embodiment, the device further includes: an acquisition component 48, coupled to the generation component 42 and configured to acquire the state information of the D2D UE in one of manners as follows:

under a condition that the D2D communication management entity is an eNB, the D2D communication management entity receives state information of UE served by the location server of the EPC, and/or, the DD2D communication management entity receives state information sent by the UE located under the network coverage, and/or, the D2D communication management entity receives state information sent by UE located outside of network coverage by forwarding of a first type of relay UE, which is under the network coverage, in the UE;

under a condition that the D2D communication management entity is an MME or a ProSe server, the D2D communication management entity receives the state information of the UE served by the location server of the EPC through an eNB, and/or, the D2D communication management entity receives the state information sent by the UE located under the network coverage through the eNB, and/or, the D2D communication management entity receives the state information sent by the UE located outside of network coverage by forwarding of the eNB and the relay UE, which is under the network coverage, in the UE; and

under a condition that all UE is outside of network coverage, the D2D communication management entity receives state information sent by UE directly neighbouring to the D2D communication management entity among the UE, and/or, the D2D communication management entity receives state information sent by UE which is not directly neighbouring to the D2D communication management entity by forwarding of a second type of relay UE in the UE.

In an exemplary embodiment, the acquisition component 48 is further configured to acquire information of multiple eNBs and state information of UE related to the multiple eNBs respectively, wherein the information of the multiple eNBs includes: information of the multiple eNBs and their neighbouring eNBs and information of UE under network coverage of each eNB; the UE related to each eNB in the multiple eNBs includes: the UE under the network coverage of each eNB, employing the UE under the network coverage of the eNBs as a first type of relay UE, outside of network coverage; and the generation component 42 is configured to generate the routing information according to the state information of the D2D UE and the information of the multiple eNBs.

In an exemplary embodiment, the acquisition component 48 is further configured to acquire the state information of each piece of UE in the D2D UE and the information of the multiple eNBs through the multiple eNBs, wherein each eNB in the multiple eNBs acquires the state information of the UE under respective network coverage, and/or, acquires the state information of the UE outside of network coverage through the first type of relay UE within its own network coverage.

In an exemplary embodiment, under a condition that the D2D communication management entity is an MME or one eNB in the multiple eNBs, the acquisition component 48 is further configured to acquire the state information of the D2D UE and the information of the multiple eNBs through each eNB in the multiple eNBs respectively, wherein each eNB in the multiple eNBs acquires the state information of the UE under respective network coverage, and/or, acquires the state information, which may be forwarded through the first type of relay UE, of the UE outside of network coverage through the first type of relay UE under respective network coverage.

In an exemplary embodiment, under a condition that the D2D communication management entity is one eNB in the multiple eNBs, the D2D communication management entity acquires the state information of the UE related to the other eNBs and the information of the other eNBs through X2 interfaces with the other eNBs in the multiple eNBs and/or an S1 interface between the eNB and a CN.

In an exemplary embodiment, under a condition that the D2D communication management entity is a ProSe server or an MME, the acquisition component 48 is further configured to acquire the state information of the D2D UE and the information of each eNB through each eNB.

In an exemplary embodiment, under a condition that the D2D UE needs to forward data through an eNB, the generation component 42 is further configured to: establish a network topology connection relationship of the D2D UE and the eNB according to the state information of the D2D UE and information of the eNB; and generate the routing information according to the network topology connection relationship.

In an exemplary embodiment, under a condition that the D2D UE is located outside of network coverage, the generation component 42 is further configured to: establish a network topology connection relationship of the D2D UE according to the state information of the D2D UE; and generate the routing information according to the network topology connection relationship.

In an exemplary embodiment, the state information of one piece of UE in the UE is determined according to feedback of the other UE about receiving conditions of discovery signals sent by the UE to the other UE, and/or is determined according to signals received by the UE from the other UE, and/or is determined according to position information, acquired from the location server of the EPC, of the UE.

In an exemplary embodiment, under a condition that the D2D UE needs to forward data through an eNB, the first sending component 44 is further configured to send the routing information of the D2D UE to the eNB.

In an exemplary embodiment, a manner for the first sending component 44 to send the routing information of the D2D UE to at least one piece of UE and/or the eNB includes one of manners as follows:

under a condition that the D2D communication management entity is an eNB, the routing information is sent to UE under the network coverage and/or the eNB, and/or, the routing information is sent to UE outside of network coverage through a first type of relay UE in the D2D UE;

under a condition that the D2D communication management entity is an MME or a ProSe server, the D2D communication management entity sends the routing information to a serving eNB of the UE, then the serving eNB of the UE sends the routing information to the UE, and furthermore, a first type of relay UE in the UE forwards the routing information to UE outside of the network coverage; and

under a condition that all UE is outside of network coverage, the D2D communication management entity sends the routing information to UE directly neighbouring to the D2D communication management entity in the D2D UE, and/or, sends the routing information to the UE which is not directly neighbouring to the D2D communication management entity through a second type of relay UE in the D2D UE.

In an exemplary embodiment, the device generates or updates the routing information according to a request of the first type of relay UE or the second type of relay UE and/or the eNB, and/or, the D2D communication management entity actively generates or updates the routing information.

In an exemplary embodiment, the updating component 46 sends the updated routing information to at least one piece of UE and/or the eNB in an incremental notification manner or a complete notification manner.

In an exemplary embodiment, under a condition that UE in the D2D UE initiates D2D communication, the device is further configured to receive a traffic starting indication sent by the UE initiating the D2D communication; and update routing information of a relay node related to D2D communication of the UE initiating the D2D communication according to the traffic starting indication, wherein the relay node includes: relay UE and/or the eNB.

In an exemplary embodiment, the traffic starting indication includes: an address of a destination node of traffic, and may further include: a duration of the traffic.

In an exemplary embodiment, after the routing information of the relay node related to D2D communication of the UE initiating the D2D communication is updated, the device is further configured to: receive a traffic ending indication sent by the UE initiating the D2D communication; and stop updating the routing information of the relay node related to D2D communication of the UE initiating the D2D communication according to the traffic ending indication.

The embodiment further provides a device for receiving routing information, which is located in D2D UE. It is important to note that the device is configured to implement the abovementioned method for receiving routing information, a structure, preferred structure and functions of the device embodiment may be directly and undoubtedly determined according to descriptions in the method embodiment, and the preferred structure of the device will not be elaborated in the embodiment.

The device for receiving routing information provided by the embodiment includes: a receiving component, configured to receive routing information used for D2D communication from a D2D communication management entity.

FIG. 5 is a preferred structure diagram of a device for receiving routing information according to an embodiment of the present disclosure, and as shown in FIG. 5, the device preferably includes: a second sending component 52 and a receiving component 54, wherein the second sending component 52 is configured to send state information to a D2D communication management entity, wherein the state information of UE is state information used for indicating a neighbouring relationship and/or link condition information between the UE and neighbouring UE, and routing information is generated by the D2D communication management entity according to the state information; and the receiving component 54 is coupled to the second sending component 52 through the D2D communication management entity, and is configured to receive the routing information used for D2D communication from the D2D communication management entity.

In an exemplary embodiment, the device is further configured to: after receiving the routing information, perform D2D communication according to the routing information, wherein the device judges whether D2D communication is able to be performed with corresponding UE or not according to the received routing information, and under a condition that a judgment result is that the D2D communication is able to be performed with the corresponding UE, initiates D2D communication to the corresponding UE, wherein the D2D communication includes one of manners as follows: unicast communication, group communication and broadcast communication.

In an exemplary embodiment, in D2D communication, under a condition that an address of a destination node of a data packet received by the device is not an address of a first type of relay UE or a second type of relay UE, the device acquires a routing information table entry to obtain a corresponding next hop according to the address of the destination node in a routing information table, and then the first type of relay UE or the second type of relay UE forwards the data packet according to a communication mode with a next-hop node and an ID of the next-hop node in the routing information, wherein the communication mode is contained in the routing information.

In an exemplary embodiment, the communication mode is contained in the routing information, or, is determined according to the ID of the next-hop node, a D2D communication manner is adopted when the next-hop node is UE, and a cellular communication manner is adopted when the next-hop node is an eNB.

In an exemplary embodiment, under a condition that the device is located in the first type of relay UE or the second type of relay UE and the number of pieces of UE neighbouring to the first type of relay UE or the second type of relay UE is more than or equal to 2, the receiving component 54 is further configured to receive D2D communication forwarding table information sent by the D2D communication management entity, wherein the D2D communication forwarding table information is configured to indicate processing of the relay UE over the received data packet in group communication and/or broadcast communication.

In an exemplary embodiment, under a condition that the first type of relay UE or the second type of relay UE is not neighbouring to the D2D communication management entity, the receiving component 54 receives the D2D communication forwarding table information through UE neighbouring to the D2D communication management entity and/or an eNB.

In an exemplary embodiment, the D2D communication forwarding table information includes: a D2D communication address of a destination node, a communication mode with the destination node and a latest data packet index.

In an exemplary embodiment, the D2D communication forwarding table information is generated by the D2D communication management entity according to a preset strategy, wherein the preset strategy includes at least one of: cellular communication preferred, D2D communication preferred and path condition sensing.

In an exemplary embodiment, the D2D communication forwarding table information generated according to the preset strategy of cellular communication preferred includes: D2D communication forwarding table information used for local routing of an eNB, and/or, D2D communication forwarding table information used for routing through a CN.

In an exemplary embodiment, under a condition that the D2D communication forwarding table information includes the D2D communication forwarding table information used for local routing of the eNB and the D2D communication forwarding table information used for routing through the CN, the device further includes a determination component 56, coupled to the receiving component 54 and configured to, before group communication and/or broadcast communication of the first type of relay UE or the second type of relay UE, determine D2D communication forwarding table information used for group communication and/or broadcast communication according to path weights of the D2D communication forwarding table information used for local routing of the eNB and the D2D communication forwarding table information used for routing through the CN.

In an exemplary embodiment, the device further includes a processing component 58, coupled to the receiving component 54 and configured to process the received data packet according to the D2D communication forwarding table information.

In an exemplary embodiment, the processing component 58 is configured to: judge whether the received data packet is consistent with a preset characteristic or not, wherein the preset characteristic includes that: the address of the destination node of the data packet is a D2D communication address and an index of the data packet is a latest data packet index in the D2D communication forwarding table information or the index of the data packet has yet not appeared in the D2D communication forwarding table information; under a condition that a judgment result indicates that the data packet is consistent with the preset characteristic, analyze the received data packet; and forward the received data packet according to a communication mode, indicated in the D2D communication forwarding table, between the first type of relay UE or the second type of relay UE and the destination node.

In an exemplary embodiment, the processing component 58 is further configured to, under a condition that the judgment result indicates that the data packet is inconsistent with the preset characteristic, discard the received data packet.

In an exemplary embodiment, the device further includes an updating component 59, coupled to the processing component 58 and configured to update the latest data packet index in the D2D communication forwarding table information.

In an exemplary embodiment, under a condition that a UE communication node topology relationship changes, the receiving component 54 is further configured to receive updating information of the D2D communication forwarding table information from the D2D communication management entity.

In an exemplary embodiment, change of the UE communication node topology relationship includes at least one of: disappearance of a UE communication node and addition of a UE communication node.

In an exemplary embodiment, the routing information is sent by the D2D communication management entity according to a request of at least one piece of UE, and/or, the routing information is actively sent by the D2D communication management entity.

The embodiment further provides a system for processing routing information, which includes the abovementioned D2D communication management entity and the abovementioned D2D UE, wherein there are multiple pieces of D2D UE, which is directly connected with the D2D communication management entity respectively, or, is connected with the D2D communication management entity through relay UE and/or an eNB.

Descriptions and introductions will be given below with reference to a preferred embodiment.

In D2D communication, for some special scenarios, it may also be necessary to forward information through a cellular network to implement normal communication between D2D UE, and implementation of such a process requires assistance of corresponding routing information. At some times, there may also exist multiple proper routes capable of providing service for communication between D2D UE, and then it is necessary to select an optimal route from them as a communication route between the D2D UE according to some given strategies to finally implement various kinds of communication between the D2D UE.

In order to achieve the purpose, the preferred embodiment provides a method for constructing and maintaining a communication route between D2D UE, including the following solution.

A D2D communication management entity sends communication routing information (i.e. the abovementioned routing information) to the D2D UE.

The D2D communication management entity may be an eNB or an MME or a ProSe server, or a function entity such as a central control node, a cluster head and a group master; and the D2D communication management entity is responsible for D2D communication management.

In an exemplary embodiment, in inside-network coverage and network coverage extended scenarios, the D2D communication management entity sends communication routing information to an eNB.

In an exemplary embodiment, the D2D communication management entity is responsible for establishing and maintaining the communication routing information.

In an exemplary embodiment, when the D2D UE is all located under the network coverage, the communication routing information at least includes: information such as an ID of an intra-group node and an ID of a next-hop node, and optional communication mode information, wherein the ID of each node is a UE ID and/or an eNB ID; the UE ID is a mobile user ID, an IP address, a logical username, a TMSI, an IMSI, an RNTI, or other ID used for UE identification; and the eNB ID may be a global eNB ID, an eNB logical name, an eNB label and the like.

In an exemplary embodiment, when the D2D UE is located in a network coverage extended scenario, the communication routing information at least includes: information such as an ID of an intra-group node and an ID of a next-hop node, an optional network position condition of the intra-group node and an optional communication mode, wherein the ID of each node is a UE ID and/or an eNB ID.

In an exemplary embodiment, when the D2D UE is all located outside of network coverage, the communication routing information at least includes: an ID of an intra-group node and an ID of a next-hop node, wherein the ID of each node is a UE ID.

In an exemplary embodiment, the D2D UE sends a message such as a neighbouring relationship with neighbouring UE and/or link condition information with the neighbouring UE to the D2D communication management entity, wherein the neighbouring relationship with the neighbouring UE is jointly represented by an ID of the UE, an ID of the neighbouring UE and the like.

In an exemplary embodiment, for D2D UE located under the network coverage, the D2D UE sends the information to an eNB after acquiring the information, and if the D2D communication management entity is not the eNB, the eNB forwards the information to the D2D communication management entity; for D2D UE outside of network coverage in the network coverage extended scenario, the D2D UE forwards the information to the eNB through neighbouring D2D UE with a forwarding function under the network coverage after acquiring the information, and if the D2D communication management entity is not the eNB, the eNB forwards the information to the D2D communication management entity; and when the D2D UE is all located outside of network coverage, UE directly neighbouring to the D2D communication management entity sends the information to the D2D communication management entity after acquiring the information, and UE which is not directly neighbouring to the D2D communication management entity sends the information to UE which is directly neighbouring to the D2D communication management entity and has the forwarding function after acquiring the information, and then the information is forwarded to the D2D communication management entity through the UE.

In an exemplary embodiment, in the inside-network coverage and network coverage extended scenarios, when the D2D communication management entity is an MME, an eNB sends a message including information related to the eNB such as information of D2D UE under network coverage of the eNB and information of D2D UE in a neighbouring relationship with the eNB under the network coverage of the eNB to the D2D communication management entity.

In an exemplary embodiment, in the inside-network coverage and network coverage extended scenarios, when the D2D UE exists in different eNBs and the D2D communication management entity is an eNB, a neighbouring eNB sends a message including information related to the eNB such as information of an eNB in a neighbouring relationship with the eNB and information of D2D UE related to the eNB to the D2D communication management entity through an X2 interface or an S1 interface.

In an exemplary embodiment, in the inside-network coverage and network coverage extended scenarios, when the D2D UE exists in different eNBs and the D2D communication management entity is a ProSe server or an MME, each eNB sends a message including information of the eNB and information of D2D UE under network coverage of the eNB to the D2D communication management entity after acquiring the information of the D2D UE under respective network coverage.

In an exemplary embodiment, within the inside-network coverage and network coverage extended scenarios, the D2D communication management entity generates a network topology connection relationship to further establish a communication routing information table after receiving a message including neighbouring relationship information of the D2D UE and the information related to the eNB.

In an exemplary embodiment, when the D2D UE is all located outside of network coverage, the D2D communication management entity generates a network topology connection relationship to further establish a communication routing information table after receiving a message including the neighbouring relationship information of the D2D UE.

In an exemplary embodiment, the neighbouring relationship and/or link condition information may be acquired according to feedback of the other UE about receiving conditions of discovery signals sent between the D2D UE, and/or signals received from the other D2D UE, and/or position information, acquired through a location server of an EPC, of the UE.

In an exemplary embodiment, when the neighbouring relationship and/or link condition information between the D2D UE changes, the D2D UE sends changed information to the D2D communication management entity to modify corresponding communication routing information.

In an exemplary embodiment, the changed information may be sent in an incremental manner or a complete manner.

In an exemplary embodiment, the D2D communication management entity may periodically or aperiodically require the D2D UE to report the neighbouring relationship and/or link condition information.

In an exemplary embodiment, when the information of the D2D UE under the network coverage of the eNB changes and/or the information of the D2D UE within the extended network coverage changes and the neighbouring relationship and/or link condition information between the UE changes, or an air interface resource occupation condition of the eNB changes, or a backhaul resource load condition of a CN changes, it is necessary to timely send the changed information to the D2D communication management entity to modify the corresponding communication routing information.

In an exemplary embodiment, the changed information may be sent in an incremental manner or a complete manner.

In an exemplary embodiment, the D2D communication management entity may periodically or aperiodically require the eNB to report the information related to the eNB.

In an exemplary embodiment, in the inside-network coverage and network coverage extended scenarios, the D2D communication management entity updates the routing information according to a routing strategy at the beginning of D2D communication.

In an exemplary embodiment, the updated routing information includes the information such as the ID of the intra-group node and the ID of the next-hop node, and the optional communication mode.

In an exemplary embodiment, the routing strategy adopted by the D2D communication management entity includes cellular communication preferred, D2D communication preferred, path condition sensing and the like.

In an exemplary embodiment, D2D UE with an enabled relay function and the eNB acquire the routing information transmitted by the D2D communication management entity.

In an exemplary embodiment, routing information of the D2D UE with the enabled relay function under the network coverage is transmitted to the eNB by the D2D communication management entity, and then is forwarded to the corresponding D2D UE.

In an exemplary embodiment, in the network coverage extended scenario, D2D UE with an enabled relay function outside of network coverage obtains routing information transmitted by the D2D communication management entity through its neighbouring D2D UE under the network coverage.

In an exemplary embodiment, in the inside-network coverage and network coverage extended scenarios, generation and updating of the routing information may be performed according to a request of the D2D UE with the enabled relay function and/or may be actively performed by the D2D communication management entity.

In an exemplary embodiment, the updated routing information is pushed in an incremental manner or a complete manner.

In an exemplary embodiment, when the D2D UE is all located outside of network coverage, the D2D communication management entity generates or updates the routing information according to a strategy such as path condition sensing at the beginning of D2D communication.

In an exemplary embodiment, the routing information includes information such as the ID of the intra-group node and the ID of the next-hop node.

In an exemplary embodiment, the D2D UE with the enabled relay function acquires the routing information transmitted by the D2D communication management entity; and the D2D UE which is not directly neighbouring to the D2D communication management entity and has the enabled relay function forwards the routing information transmitted by the D2D communication management entity through another piece of UE neighbouring to the D2D communication management entity.

In an exemplary embodiment, generation and updating of the routing information may be performed according to the request of the D2D UE with the enabled relay function and/or may be actively performed by the D2D communication management entity.

In an exemplary embodiment, the updated routing information is pushed in an incremental manner or a complete manner.

In an exemplary embodiment, when D2D UE initiates D2D communication, whether communication with corresponding UE intended to communicate with it may be performed or not is judged according to the acquired routing information.

In an exemplary embodiment, when it is determined that communication may be performed, a data packet is sent to neighbouring UE for corresponding communication according to the acquired routing information.

In an exemplary embodiment, when the corresponding UE intended to communicate with the D2D UE is determined to be unreachable, communication is given up.

In an exemplary embodiment, when the D2D UE performs unicast communication, group communication and/or broadcast communication with the other D2D UE and the D2D UE with the enabled relay function receives a data packet of which a target address is not the address of the UE, a routing information table is searched for routing information such as a next-hop forwarding node and communication mode corresponding to a node with the target address, then the data packet is packaged according to the corresponding communication mode, and the data packet is forwarded to the next-op node to implement a corresponding communication process.

In an exemplary embodiment, when the D2D UE performs group communication and/or broadcast communication, the D2D communication management entity establishes a D2D communication forwarding table for the UE which has the enabled relay function and of which the number of neighbouring D2D UE is more than or equal to 2 on the basis of establishing and maintaining a communication routing information table, and the D2D communication management entity establishes a network topology structure according to the acquired UE information, establishes a minimum spanning tree according to a communication condition of the node, limits forwarding of the relay node and establishes D2D communication forwarding table information for the UE of which the number of the neighbouring UE is more than or equal to 2, wherein the D2D communication forwarding table at least includes: a field content such as a target communication node, a communication mode and a latest data packet index; and the target communication node is a D2D communication address.

In an exemplary embodiment, a strategy according to which the D2D communication management entity establishes the D2D communication forwarding table includes cellular communication preferred, D2D communication preferred, path condition sensing and the like.

In an exemplary embodiment, a cellular communication manner may further be divided into two manners of local routing of an eNB and routing through a CN, and different path weight values are calculated respectively.

In an exemplary embodiment, the D2D communication management entity transmits the established D2D communication forwarding table to the D2D UE which has the enabled relay function and of which the number of the neighbouring D2D UE is more than or equal to 2; and for relay D2D UE which is not directly neighbouring to the D2D communication management entity, the D2D communication forwarding table is forwarded through the D2D UE neighbouring to the D2D communication management entity.

In an exemplary embodiment, the D2D UE processes the received data packet according to the acquired D2D communication forwarding table.

In an exemplary embodiment, a processing method is as follows: when a target address of the data packet received by the UE is the D2D communication address and an index of the data packet is more than the latest data packet index in the forwarding table or has yet not appeared, the UE analyzes the data packet, and forwards the data packet according to the corresponding communication mode; otherwise the UE discards the data packet.

In an exemplary embodiment, the D2D UE updates the data packet index after implementing forwarding of the data packet.

In an exemplary embodiment, when a UE communication node topology relationship changes, the D2D communication management entity timely updates the corresponding D2D communication forwarding table for the corresponding node, wherein change of the UE communication node topology relationship includes disappearance of a UE communication node, addition of a UE communication node and the like.

In an exemplary embodiment, the D2D communication management entity may transmit the forwarding information to a communication node with an enabled relay function and a D2D communication forwarding requirement in a manner of active requesting of the D2D UE or an active pushing manner.

In an exemplary embodiment, a node initiating communication sends a traffic starting indication to the D2D communication management entity at the beginning of communication.

In an exemplary embodiment, the traffic starting indication includes a destination address, duration and the like of traffic.

In an exemplary embodiment, after the D2D communication management entity receives the traffic starting indication, latest routing information is sent to an involved relay node when needed until the D2D communication management entity receives a traffic ending indication.

In an exemplary embodiment, in the inside-network coverage and/or network coverage extended scenario(s), when an eNB is required for data forwarding, the eNB judges whether next-hop D2D UE enters a DRX state or not at first.

In an exemplary embodiment, if the D2D UE enters the DRX state, data is sent in a next on duration/active time of the UE.

In an exemplary embodiment, in group communication, if an eNB plans to send data to D2D UE served by the eNB in a communication group in a multicast manner and there is D2D UE entering a DRX state, a group communication prenotice is sent through a PDCCH in an on duration/active time of the UE; and a multicast data packet is sent after all D2D UE served by the eNB in the communication group all enters the DRX state.

In an exemplary embodiment, the eNB configures the same DRX parameter for the D2D UE under the network coverage.

By the D2D UE communication route establishment method provided by the preferred embodiment, establishment of a communication route of the D2D UE under the network coverage may be implemented, and the method is also applicable to establishment of a communication route of D2D UE in the network coverage extended scenario as well as establishment of a communication route of D2D UE in an outside-network coverage scenario; and Quality of Service (QoS) of a user may also be improved.

Description will be given below with reference to the drawings and specific examples.

### Preferred Embodiment 1

The embodiment describes a process that the D2D UE detects and acquires its own neighbouring relationship.

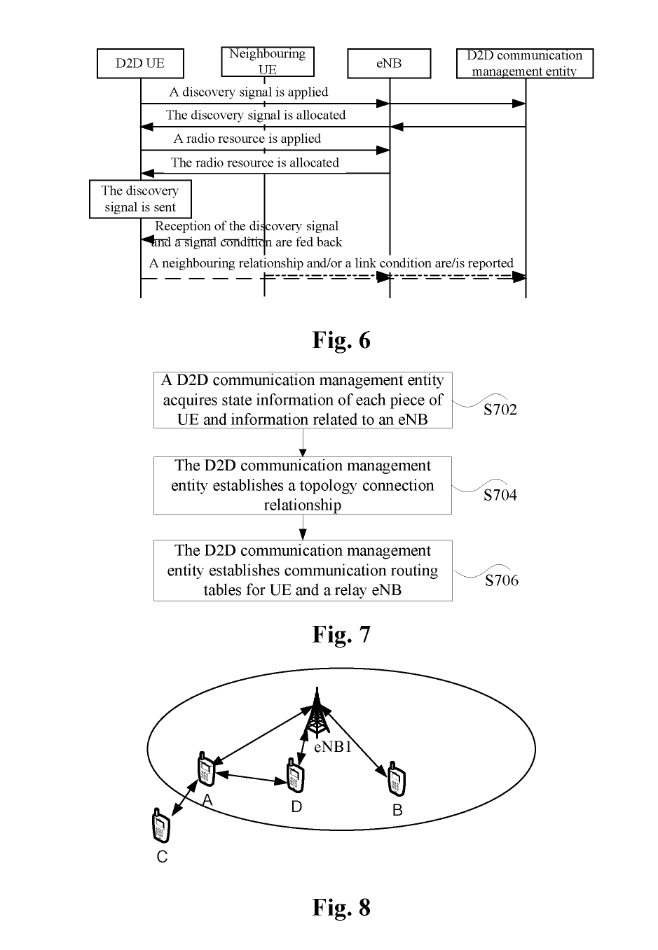

FIG. 6 is a flowchart that D2D UE detects and acquires its own neighbouring relationship according to a preferred embodiment of the present disclosure, and as shown in FIG. 6, the flow includes the following step.

D2D UE acquires information of D2D UE in a neighbouring relationship with it and other D2D UE by a discovery signal sending and receiving method, for example:

in inside-network coverage and network coverage extended scenarios, D2D UE under network coverage makes an application to a D2D communication management entity for a sent discovery signal and makes an application to an eNB for a radio resource; D2D UE outside of network coverage makes an application to the D2D communication management entity for a sent discovery signal and makes an application to the eNB for a radio resource through neighbouring D2D UE with a forwarding function under the network coverage; and when the D2D UE is all located outside of network coverage, the D2D UE makes an application to the D2D communication management entity for the sent discovery signal or obtains the discovery signal in a completion manner, and makes an application to a cluster head/group master which manages the radio resource for the radio resource or obtains the radio resource in the competition manner.

The D2D UE sends the discovery signal according to a set rule after obtaining the discovery signal and the radio resource. Neighbouring D2D UE returns a corresponding response signal and information of a signal condition and the like of the received discovery signal after receiving the discovery signal; and/or the D2D UE obtains a neighbouring relationship with the neighbouring relationship directly according to the discovery signal received from the neighbouring UE. The D2D UE collects information of the other D2D UE in the neighbouring relationship with it in such a manner, acquires link condition data with the neighbouring D2D UE according to sending and receiving conditions of the discovery signals, and acquires information such as whether the neighbouring D2D UE has an enabled relay function or not.

The D2D UE sends a message including information such as the neighbouring relationship and a link condition to the D2D communication management entity through an eNB. The D2D UE under the network coverage sends a message to the D2D communication management entity directly through the eNB; and the D2D UE outside of network coverage sends a message to the D2D communication management entity through its neighbouring D2D UE with a forwarding function under the network coverage and the eNB.

Or the neighbouring UE obtains the neighbouring relationship and/or the link condition data by sensing the discovery signals sent by the UE, and the D2D UE under the network coverage sends them to the D2D communication management entity directly through the eNB; and the D2D UE outside of network coverage sends them to the D2D communication management entity through its neighbouring D2D UE with the forwarding function under the network coverage and the eNB.

### Preferred Embodiment 2

The embodiment describes a process of establishing communication routing table information by a D2D communication management entity in inside-network coverage and network coverage extended scenarios.

FIG. 7 is a flowchart of communication routing table information establishment of a D2D communication management entity in inside-network coverage and network coverage extended scenarios according to a preferred embodiment of the present disclosure, and as shown in FIG. 7, the flow includes the following steps.

Step S702: a D2D communication management entity acquires a neighbouring relationship of each piece of UE and information related to an eNB.

For example, after acquiring information of other D2D UE in the neighbouring relationship with it and/or link condition data with the neighbouring D2D UE, D2D UE sends a message including the information to the D2D communication management entity. For D2D UE under network coverage, the D2D UE sends the acquired information to the eNB, and if the D2D communication management entity is not the eNB, the eNB forwards the information to the D2D communication management entity; and for D2D UE outside of network coverage in the network coverage extended scenario, the D2D UE forwards the acquired information to the eNB through its neighbouring D2D UE with a forwarding function under the network coverage, and if the D2D communication management entity is not the eNB, the eNB forwards the information to the D2D communication management entity. When the neighbouring relationship of the D2D UE under the network coverage is obtained by a location server of an EPC, the location server of the EPC provides position information, such as longitude and latitude information, of each piece of UE under the eNB at first, and then obtains respective neighbouring relationship of the UE according to the position information of the UE.

The D2D communication management entity acquires the information related to the eNB. In the inside-network coverage and network coverage extended scenarios, when the D2D communication management entity is an MME, the eNB sends a message including the information related to the eNB such as information of the D2D UE under the network coverage of the eNB and information of the D2D UE in the neighbouring relationship with the eNB under the network coverage of the eNB to the D2D communication management entity; when the UE exists in different eNBs in the inside-network coverage and network coverage extended scenarios and the D2D communication management entity is an eNB, a neighbouring eNB sends a message including information related to the eNB such as information of D2D UE under network coverage of an eNB in the neighbouring relationship with the eNB to the D2D communication management entity through an X2 interface or an S1 interface; and in the inside-network coverage and network coverage extended scenarios, when the D2D communication management entity is a ProSe server and the D2D UE exists in different eNBs, each eNB sends a message including information related to the eNB such as information of the eNB and information of D2D UE under network coverage of the eNB to the D2D communication management entity after acquiring the information of the D2D UE under respective network coverage.

Step S704: the D2D communication management entity establishes a topology connection relationship, wherein the D2D communication management entity generates a network topology connection relationship after receiving the message including neighbouring relationship information of the D2D UE and the information related to the eNB.

Step S706: the D2D communication management entity establishes a communication routing table (i.e. routing information and routing table information) for the UE and a relay eNB.

### Preferred Embodiment 3

The embodiment describes an example of a communication routing table information establishment process in a network coverage extended scenario.

FIG. 8 is a diagram of a communication routing table information establishment process in a network coverage extended scenario according to a preferred embodiment of the present disclosure, and referring to FIG. 8, the process includes the following steps.

In a network coverage extended scenario, UE A, UE B, UEC and UE D are UE with an enabled D2D communication function, wherein UE A, UE B and UE D are under network coverage, UE C is outside of network coverage but within a D2D communication range of UE A, UE B is outside D2D communication ranges of the other UE but under the network coverage, and may communicate with UE A and UE C through a cellular network, and UE A has a relay function, and may receive and forward D2D communication and cellular communication.

At the beginning of D2D communication among the UE, it is necessary to establish a communication routing information table of the UE with a relay forwarding function and a communication routing information table of an eNB which forwards D2D data. At first, each piece of UE makes applications to a D2D communication management entity and eNB1 for discovery signals and radio resources, or obtains the discovery signals and the radio resources in a competition manner, and sends the discovery signals according to a rule after acquiring the resources, thereby acquiring neighbouring relationships and/or link conditions with neighbouring UE from responses fed back by the neighbouring UE; or the neighbouring UE directly sends the neighbouring relationships and/or the link conditions to eNB1 by sensing the discovery signals sent by the UE, and then the neighbouring relationships and/or the link conditions are sent to the D2D communication management entity through eNB1, wherein neighbouring relationships and/or link conditions, with neighbouring UE, of UE C outside of network coverage are sent to neighbouring UE A in a connection relationship with eNB1 to be further sent to eNB1, and then are finally sent to the D2D communication management entity. The D2D communication management entity establishes a topology connection relationship among the UE according to the neighbouring relationships, fed back by each piece of UE, with the neighbouring UE, and then establishes routing information of UE A and eNB1 according to information of eNB1. A routing information table entry of UE A includes neighbouring UE C and UE D capable of performing D2D communication with it and neighbouring UE B capable of performing cellular communication. A routing information table entry of eNB1 includes its UE A, UE B and UE D capable of performing cellular communication and UE C capable of performing communication after relay of UE A.

Table 1˜Table 5 show corresponding routing table information respectively, as follows:

TABLE 1
Routing Table Information of UE A
Routing table of UE A

| ID of | Network coverage | | ID of |
|---|---|---|---|
| sending | position condition | Communication mode | next-hop |
| node | (optional) | (optional) | node |
| B | Under network | Cellular communication | eNB1 |
| | coverage | | |
| C | Outside of network | D2D communication | C |
| | coverage | | |
| D | Under network | D2D communication | D |
| | coverage | | |

TABLE 2
Routing Table Information of eNB1
Routing table of eNB1

| ID of | Network coverage | | ID of |
|---|---|---|---|
| sending | position condition | Communication mode | next-hop |
| node | (optional) | (optional) | node |
| A | Under network | Cellular communication | A |
| | coverage | | |
| B | Under network | Cellular communication | B |
| | coverage | | |
| C | Outside of network | Cellular communication | A |
| | coverage | | |
| D | Under network | Cellular communication | D |
| | coverage | | |

TABLE 3
Routing Table Information of UE B
Routing table of UE B

| ID of | Network coverage | | ID of |
|---|---|---|---|
| sending | position condition | Communication mode | next-hop |
| node | (optional) | (optional) | node |
| A | Under network | Cellular communication | eNB1 |
| | coverage | | |
| D | Under network | Cellular communication | eNB1 |
| | coverage | | |

TABLE 4
Routing Table Information of UE C
Routing table of UE C

| ID of | Network coverage | | ID of |
|---|---|---|---|
| sending | position condition | Communication mode | next-hop |
| node | (optional) | (optional) | node |
| A | Under network | D2D communication | A |
| | coverage | | |
| D | Under network | D2D communication | A |
| | coverage | | |

TABLE 5
Routing Table Information of UE D
Routing table of UE D

| ID of | Network coverage | | ID of |
|---|---|---|---|
| sending | position condition | Communication mode | next-hop |
| node | (optional) | (optional) | node |
| A | Under network | D2D communication | A |
| | coverage | | |
| B | Under network | Cellular communication | eNB1 |
| | coverage | | |
| C | Under network | D2D communication | A |
| | coverage | | |

From the abovementioned routing table information, it can be seen that a sending node in routing table information of UE usually does not include its own node ID information.

The routing table information in the tables shows neighbouring conditions and communication manners of UE and the other UE, wherein the communication modes in the routing table information of the eNB identify communication modes between the eNB and the corresponding UE, for example, a cellular communication mode shown in FIG. 2. Information fields in a routing information table include: an ID of a sending node, an ID of a next-hop node, an optional network position condition of the sending node and an optional communication mode, wherein the ID of the sending node includes nodes neighbouring to the UE, and does not include eNB1 but each piece of UE; the network position condition of the sending node refers to whether the node neighbouring to the UE is located under the network coverage or not; the communication mode refers to whether a connection manner for the UE and its neighbouring UE adopts a direct D2D communication manner or a cellular communication manner; and the ID of the next-hop node indicates the network node of the UE, which transmits information to a currently connected node, to indicate whether there is a relay or not.

“Optional” in Table 1˜Table 5 refers to the table entry is an optional entry, and in some preferred implementation modes, the table entry may be removed or the table entry may not be configured.

Before communication is established, the D2D communication management entity transmits the communication routing information to UE A, UE B and UE C through eNB1, UE C obtains the communication routing information by forwarding of UE A, and meanwhile, eNB1 obtains its own communication routing table information from the D2D communication management entity.

When UE C wants to send a data packet to UE B, UE C judges whether UE B is reachable for a route or not according to the routing information at first, and determines that path UE C→UE A→eNB1→UE B may be adopted for implementation. When eNB1 forwards data from UE A to UE B, a Serving Gateway/Packet Data Network Gateway (S-GW/P-GW)-based manner may be adopted, a local switch manner may also be adopted, and the adopted manner needs to be specifically determined according to a function of the eNB, a strategy of an operating company and the like.

### Preferred Embodiment 4

The embodiment describes an example of a cross-eNB communication routing table information establishment process in a D2D communication scenario.

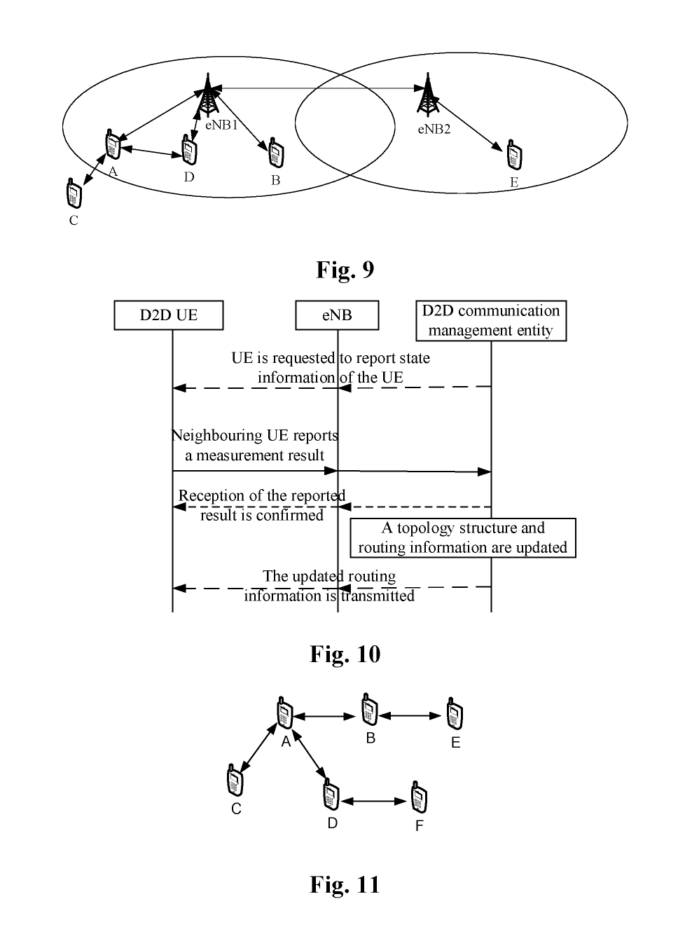

FIG. 9 is a diagram of a cross-eNB communication routing table information establishment process in a D2D communication scenario according to a preferred embodiment of the present disclosure, and referring to FIG. 9, the process includes the following steps.

During D2D communication of D2D UE belonging to different eNBs, it is necessary to establish routing data for the UE in the same group at first, the data is directly transmitted through an X2 interface when there exists the X2 communication interface, and when the X2 communication interface does not exist, it is necessary to transmit the data through an S1 interface defined by a specification.

In a network coverage extended scenario, UE A, UE B, UE C, UE D and UE E are UE with an enabled D2D communication function, wherein UE A, UE B and UE D are under network coverage of eNB1, UE E is under network coverage of eNB2, UE C is outside of network coverage of eNB1 and eNB2 but within a D2D communication range of UE A, UE A has a relay function, and may receive and forward D2D communication and cellular communication, and an X2 communication interface exists between eNB1 and eNB2.

At the beginning of D2D communication among the UE, UE A, UE B and UE D make applications to a D2D communication management entity and eNB1 for discovery signals and radio resources, or obtain the discovery signals and the radio resources in a competition manner, and send the discovery signals according to a rule after acquiring the resources, thereby acquiring neighbouring relationships and/or link conditions with neighbouring UE from responses fed back by the neighbouring UE and then sending the relationships and/or the link conditions to the D2D communication management entity through eNB1; UE E makes applications to the D2D communication management entity and eNB2 for a discovery signal and a radio resource, or obtains the discovery signal and the radio resource in the competition manner, and sends the discovery signal according to a rule after acquiring the resource, thereby acquiring neighbouring relationships and/or link conditions with neighbouring UE from responses fed back by the neighbouring UE and then sending the relationships and/or the link conditions to the D2D communication management entity through eNB2; and in addition, UE C outside of network coverage acquires a discovery signal and a radio resource through neighbouring UE A in a connection relationship with eNB1, and sends the discovery signal according to a rule after acquiring the resource, thereby acquiring neighbouring relationships and/or link conditions with neighbouring UE from responses fed back by the neighbouring UE, then transmitting the neighbouring relationships and/or the link conditions to eNB1 through UE A and finally transmitting them back to the D2D communication management entity. The D2D communication management entity establishes a topology connection relationship among the UE according to the neighbouring relationships, fed back by each piece of UE, with the neighbouring UE, and then establishes routing information tables of UE A, UE B, UE C, UE D, UE E, eNB1 and eNB2. When the routing information tables are established, eNB1 and eNB2 may be considered not to exist for the neighbouring relationships of the UE, and eNB1 and eNB2 are also transparently connected; and in addition, data transmission among the UE may be implemented by direct forwarding transmission between the eNBs, and whether it is necessary to transmit the data through a CN or not may be determined according to capabilities of the eNBs and/or a strategy of a network operating company and/or the like.

Table 6˜Table 12 show corresponding routing table information respectively, as follows.

TABLE 6
Routing Table Information of eNB1
Routing table of eNB1

| ID of | Network coverage | | ID of |
|---|---|---|---|
| sending | position condition | Communication mode | next-hop |
| node | (optional) | (optional) | node |
| A | Under network | Cellular communication | A |
| | coverage | | |
| B | Under network | Cellular communication | B |
| | coverage | | |
| C | Outside of network | Cellular communication | A |
| | coverage | | |
| D | Under network | Cellular communication | D |
| | coverage | | |
| E | Under network | Cellular communication | eNB2 |
| | coverage | (X2 communication) | |

TABLE 7
Routing Table Information of eNB2
Routing table of eNB2

| ID of | Network coverage | | ID of |
|---|---|---|---|
| sending | position condition | Communication mode | next-hop |
| node | (optional) | (optional) | node |
| E | Under network | Cellular communication | E |
| | coverage | | |
| A | Under network | Cellular communication | eNB1 |
| | coverage | (X2 communication) | |
| B | Outside of network | Cellular communication | eNB1 |
| | coverage | (X2 communication) | |
| D | Under network | Cellular communication | eNB1 |
| | coverage | (X2 communication) | |

TABLE 8
Routing Table Information of UE A
Routing table of UE A

| ID of | Network coverage | | ID of |
|---|---|---|---|
| sending | position condition | Communication mode | next-hop |
| node | (optional) | (optional) | node |
| B | Under network | Cellular communication | eNB1 |
| | coverage | | |
| C | Outside of network | D2D communication | C |
| | coverage | | |
| D | Under network | D2D communication | D |
| | coverage | | |
| E | Under network | Cellular communication | eNB2 |
| | coverage | (X2 communication) | |

TABLE 9
Routing Table Information of UE B
Routing table of UE B

| ID of | Network coverage | | ID of |
|---|---|---|---|
| sending | position condition | Communication mode | next-hop |
| node | (optional) | (optional) | node |
| A | Under network | Cellular communication | eNB1 |
| | coverage | | |
| D | Under network | Cellular communication | eNB1 |
| | coverage | | |
| E | Under network | Cellular communication | eNB2 |
| | coverage | (X2 communication) | |

TABLE 10
Routing Table Information of UE C
Routing table of UE B

| ID of | Network coverage | | ID of |
|---|---|---|---|
| sending | position condition | Communication mode | next-hop |
| node | (optional) | (optional) | node |
| A | Under network | Cellular communication | eNB1 |
| | coverage | | |
| D | Under network | Cellular communication | eNB1 |
| | coverage | | |

TABLE 11
Routing Table Information of UE D
Routing table of UE D

| ID of | Network coverage | | ID of |
|---|---|---|---|
| sending | position condition | Communication mode | next-hop |
| node | (optional) | (optional) | node |
| A | Under network | D2D communication | A |
| | coverage | | |
| B | Under network | Cellular communication | eNB1 |
| | coverage | | |
| C | Outside of network | D2D communication | A |
| | coverage | | |
| E | Under network | Cellular communication | eNB2 |
| | coverage | (X2 communication) | |

TABLE 12
Routing Table Information of UE E
Routing table of UE A

| ID of | Network coverage | | ID of |
|---|---|---|---|
| sending | position condition | Communication mode | next-hop |
| node | (optional) | (optional) | node |
| A | Under network | Cellular communication | eNB1 |
| | coverage | (X2 communication) | |
| B | Under network | D2D communication | eNB1 |
| | coverage | (X2 communication) | |
| D | Under network | D2D communication | eNB1 |
| | coverage | (X2 communication) | |

From the abovementioned routing table information, it can be seen that a sending node in routing table information of UE usually does not include its own node ID information.

Fields in the routing information tables of UE A, UE B, UE C, UE D, UE E, eNB1 and eNB2 include an ID of a sending node, an ID of a next-hop node, an optional network position condition of the sending node and an optional communication mode, wherein the ID of the sending node includes nodes neighbouring to the UE, and does not include eNB1 and eNB2 but each piece of UE; the network position condition of the sending node refers to whether the node neighbouring to the UE is located under the network coverage of eNB1 or eNB2 or not; the communication mode refers to whether a connection manner for the UE and its neighbouring UE adopts a direct D2D communication manner or a cellular communication manner; and the ID of the next-hop node indicates the network node of the UE, which transmits information to a currently connected node, to indicate a relay forwarding route.

Before communication is established, the D2D communication management entity transmits the routing information table of UE A under the network coverage of eNB1 through eNB1; and eNB1 and eNB2 obtains its own communication routing information tables from the D2D communication management entity.

When UE C wants to send a data packet to UE E, UE C judges whether UE E is reachable for a route or not according to the routing information at first, and determines that path UE C→UE A→eNB1→eNB2→UE E may be adopted for implementation. Forwarding between eNB1 and eNB2 may be implemented through an S-GW/P-GW, and may also be implemented by directly establishing a tunnel between eNB1 and eNB2.

### Preferred Embodiment 5

The embodiment describes a process of updating routing information after a neighbouring relationship between UE changes.

FIG. 10 is a diagram of a process of updating routing information after a neighbouring relationship between D2D UE changes according to a preferred embodiment of the present disclosure, and referring to FIG. 10, the process includes the following steps.

A D2D communication management entity requires related D2D UE to feed back and report a neighbouring relationship and/or link condition information with other UE through an eNB;

the UE monitors the neighbouring relationship with the other UE, and acquires change condition of the neighbouring relationship, link condition information and the like with the other UE;

the UE feeds back the changed neighbouring relationship with the other UE to the D2D communication management entity through the eNB, wherein feedback information may adopt change modification form to reduce a volume of data contained in a message, and the UE may also completely feed back its own latest obtained neighbouring relationships with the other UE; and the D2D communication management entity may confirm that a reported information result is received to the UE through the eNB according to a practical requirement.

The D2D communication management entity performs routing calculation again after receiving the changed neighbouring relationship between the UE and the other UE, and updates associated node routing information. The updated routing information is sent to influenced UE or all the related UE through the eNB, in either an incremental sending manner or a complete sending manner.

### Preferred Embodiment 6

The embodiment describes a process of establishing and managing communication routing information when D2D UE is all located outside of network coverage.

FIG. 11 is a diagram of a process of establishing and managing communication routing information when D2D UE is all outside of network coverage according to a preferred embodiment of the present disclosure, and referring to FIG. 11, the process includes the following step.

UE A, UE B, UE C, UE D, UE E and UE F are D2D UE located outside of network coverage, and they are UE with an enabled D2D communication function, and may all perform relay communication for other UE.

UE A˜UE F negotiate to determine a certain piece of UE as a central control node (there may also be multiple central control nodes) according to geographical positions, and/or UE A˜UE F negotiate to determine or preset a certain piece of UE as a cluster head (or called a group master and the like), for example, UE A is the cluster head, and its function is similar to a D2D communication management entity when the UE is under network coverage, responsible for D2D communication management of D2D UE. A communication resource allocation and management manner is determined by a specific resource management manner.

Each piece of UE acquires a discovery signal and a corresponding radio resource from the cluster head in a competition manner, and acquires information such as a neighbouring relationship and/or link condition and/or the like with neighbouring UE according to a response fed back by the neighbouring UE.

UE (such as UE B, UE C and UE D) directly neighbouring to the D2D communication management entity (UE A) sends the acquired information to the D2D communication management entity, UE (such as UE E and UE F) which is not directly neighbouring to the D2D communication management entity sends the acquired information to UE which is directly neighbouring to the D2D communication management entity and has a forwarding function for forwarding to the D2D communication management entity (for example, UE E sends the acquired information to UE B at first, and then UE B forwards the information to UE A serving as the D2D communication management entity).

The D2D communication management entity generates a network topology connection relationship to further establish a communication routing information table for UE with a relay requirement after receiving a message including neighbouring relationship information of the D2D UE; and communication routing information table entry fields at least include: an ID of an intra-group node and an ID of a next-hop forwarding node.

Table 13˜Table 18 show corresponding routing table information respectively, as follows.

TABLE 13
Routing Table Information of UE A
Routing Table of UE A

| ID of sending node | ID of next-hop node |
|---|---|
| B | B |
| C | C |
| D | D |
| E | B |
| F | D |

TABLE 14
Routing Table Information of UE B
Routing Table of UE B

| ID of sending node | ID of next-hop node |
|---|---|
| A | A |
| E | E |
| C | A |
| D | A |

TABLE 15
Routing Table Information of UE C
Routing Table of UE C

| ID of sending node | ID of next-hop node |
|---|---|
| A | A |
| B | A |
| D | A |

TABLE 16
Routing Table Information of UE D
Routing Table of UE D

| ID of sending node | ID of next-hop node |
|---|---|
| A | A |
| F | F |
| B | A |
| C | A |

TABLE 17
Routing Table Information of UE E
Routing Table of UE E

| ID of sending node | ID of next-hop node |
|---|---|
| A | B |
| B | B |

TABLE 18
Routing Table Information of UE F
Routing Table of UE F

| ID of sending node | ID of next-hop node |
|---|---|
| A | D |
| D | D |

D2D UE directly neighbouring to the D2D communication management entity acquires a communication routing information table transmitted by the D2D communication management entity (for example, UE B, UE C and UE D may directly acquire the communication routing information tables transmitted by UE A serving as the D2D communication management entity); and a communication routing information transmitted by the D2D communication management entity is forwarded to UE which is not directly neighbouring to the D2D communication management entity through other UE neighbouring to the D2D communication management entity (for example, UE E obtains the communication routing information table transmitted by UE A serving as the D2D communication management entity through UE B with the relay function).

After the neighbouring relationship of the D2D UE changes, the D2D UE needs to timely send the changed information to the D2D communication management entity to modify the corresponding communication routing information; and the updated routing information may be pushed either in an incremental manner or a complete sending manner.

During communication of the D2D UE, generation and updating of the routing information may be performed according to a request of the UE and/or actively performed by the D2D communication management entity.

### Preferred Embodiment 7

The embodiment describes a process of performing communication between D2D UE according to routing information.

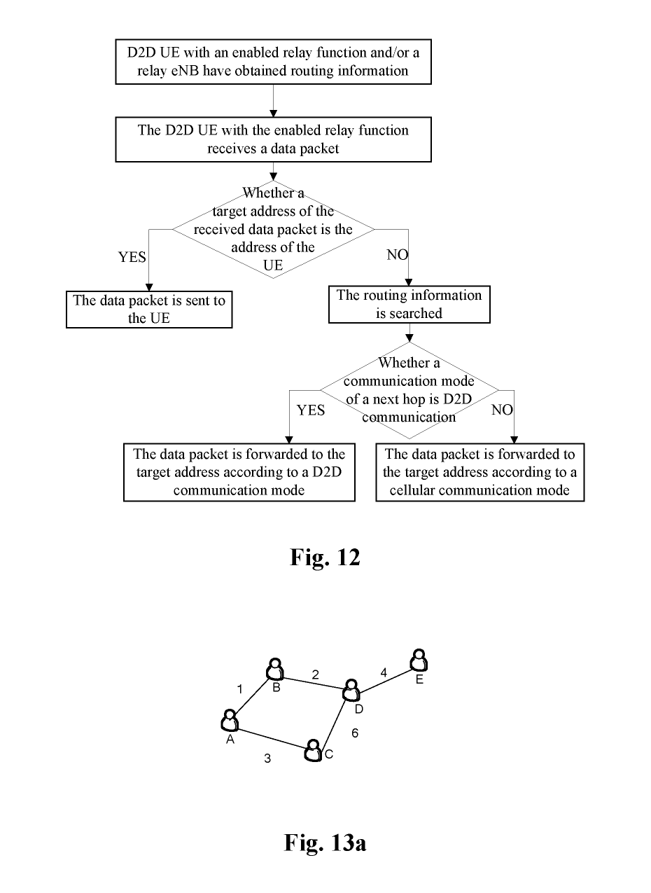

FIG. 12 is a diagram of a process of performing communication between D2D UE according to routing information according to a preferred embodiment of the present disclosure, and as shown in FIG. 12, the flow includes the following step.

When D2D UE performs unicast communication, group communication and/or broadcast communication with other UE, the D2D UE and/or an eNB has obtained routing information.

When initiating D2D communication, the D2D UE judges whether communication may be performed with corresponding UE intended to communicate with it or not according to the acquired routing information; when it is determined that communication may be performed, a data packet is sent to neighbouring UE for corresponding communication according to the acquired routing information; and when it is determined that the corresponding UE intended to communicate with it is unreachable, communication is discarded.

After receiving a data packet, D2D UE with an enabled relay function detects a target address of the received data packet, and if the data packet is own data packet of the UE, it is indicated that the data packet is sent to the UE; and if the data packet is not the data packet of the UE, a routing information table is searched for an ID of a next-hop node and communication mode corresponding to a node with the target address, the corresponding communication mode is obtained according to the ID of the next-hop node when the communication mode is not directly configured in the communication routing information table, a D2D communication mode being adopted when the ID of the next-hop node is UE and a cellular communication mode being adopted when the ID of the next-hop node is an eNB, then the data packet is packaged according to the corresponding communication mode, the data packet is forwarded to the next-hop node, and the next-hop node implements a corresponding communication process according to the received data packet and communication routing table information.

The communication mode may be D2D communication or cellular communication, D2D communication indicates forwarding between the UE, and the data packet is forwarded to the target address according to the D2D communication mode; and cellular communication indicates data packet forwarding through the eNB, and the UE forwards data to the corresponding UE through the eNB cellular communication mode. The communication mode in the routing information is determined by the D2D communication management entity according to a communication strategy.

### Preferred Embodiment 8

The embodiment describes a process of generating routing information for group communication of D2D UE in a D2D communication group.

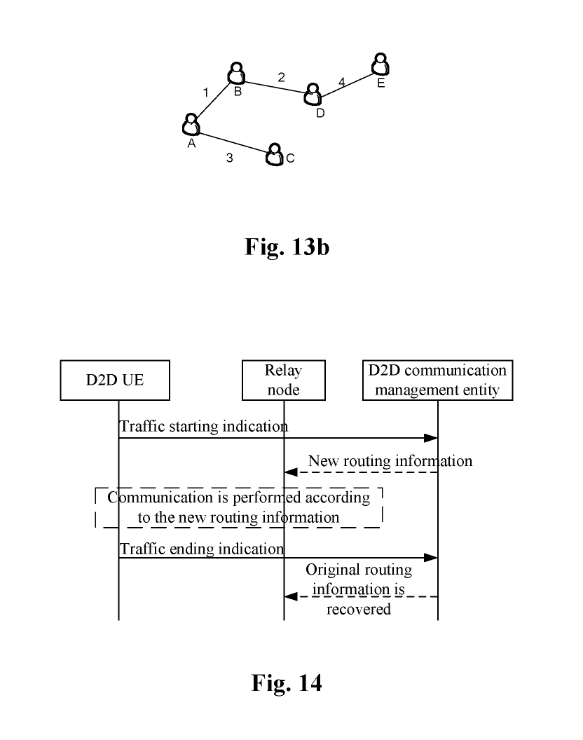

FIG. 13a and FIG. 13b are diagrams of processes of generating routing information for group communication of D2D UE in a D2D communication group according to a preferred embodiment of the present disclosure, and referring to FIG. 13a and FIG. 13b, the flow includes the following steps.

It is supposed that nodes A, B, C, D and E belong to communication group X, and node A in the group is expected to send a data packet to all the other nodes in the group. Since nodes D and E are outside a reachable range of a hop of node A, the data packet needs to be forwarded through another node in the group. As shown in FIG. 13a, there are two nodes, nodes B and C respectively, neighbouring to node D in communication group X, and a resource may be wasted if nodes B and C forward the data packet, so that it is better to establish a minimum spanning tree to limit forwarding of relay nodes according to a communication condition of the nodes according to a node distribution topology of communication group X. As shown in FIG. 13b, the data packet from node A to communication group X is only forwarded through node B and node D, and since node C has only one associated edge on the minimum spinning tree, a forwarding function is suppressed.

For a relay node of which the number of associated edges is more than or equal to 2 on the minimum spanning tree, it is necessary to store a D2D communication forwarding table, the table recording a D2D communication address, a communication mode and an index of a data packet which is received before. Table 19 is a forwarding table example for the example shown in FIG. 13a.

TABLE 19
Forwarding Table Example

| | | Latest data |
|---|---|---|
| Target communication node | Communication mode | packet index |
| D2D communication address | D2D communication | XXXX |

When a target address of a data packet received by node B is a D2D communication address and an index of the data packet is more than the latest data packet index in the forwarding table or has yet not appeared, node B analyzes the data packet, and forwards the data packet according to the corresponding communication mode, otherwise node B discards the data packet. Node B updates the data packet index after implementing forwarding of the data packet.

When a forwarding node changes, for example, the forwarding node disappears and/or the forwarding node is added, the D2D communication management entity needs to timely update a corresponding D2D communication forwarding table for the corresponding node.

The D2D communication management entity may transmit forwarded information to a node, which has an enabled relay function and a group communication forwarding requirement, in the communication group in a manner of active requesting of the D2D UE or an active pushing manner.

### Preferred Embodiment 9

The embodiment describes a traffic indication control process in a communication process.

FIG. 14 is a diagram of a traffic indication control process in a communication process according to a preferred embodiment of the present disclosure, and referring to FIG. 14, the process includes the following steps.

At the beginning of communication, a node initiating communication sends a traffic starting indication, such as a destination address, duration and the like of traffic, to a D2D communication management entity; and

after receiving the traffic starting indication, the D2D communication management entity sends latest routing information to an involved relay node when needed until the D2D communication management entity receives a traffic ending indication.

### Preferred Embodiment 10

The embodiment describes a process of DRX coordination of a communication process in (an) inside-network coverage and/or network coverage extended scenario(s).

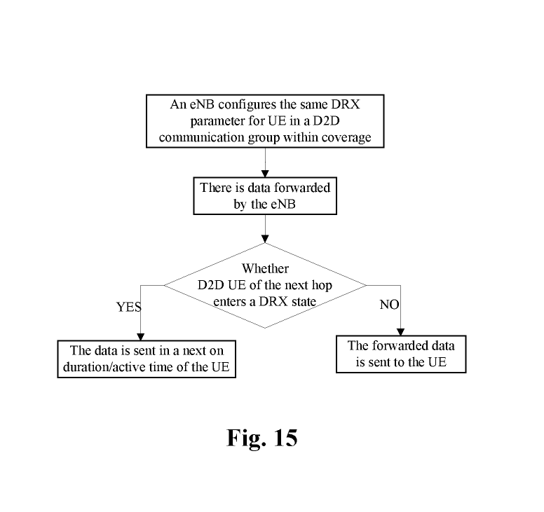

FIG. 15 is a diagram of a process of DRX coordination of a communication process in inside-network coverage and network coverage extended scenarios according to a preferred embodiment of the present disclosure, and referring to FIG. 15, the process includes the following steps.

In (an) inside-network coverage and/or network coverage extended scenario(s), an eNB configures the same DRX parameter for D2D UE under network coverage;

when the eNB receives data required to be forwarded through the eNB, the eNB judges whether D2D UE of the next hop enters a DRX state or not at first;

if the D2D UE enters the DRX state, the data is sent in a next on duration/active time of the UE, otherwise the data is sent to corresponding UE according to a forwarding address;

during group communication, if the eNB plans to send the data to D2D UE served by the eNB in a communication group in a multicast manner and there is D2D UE entering the DRX state, a group communication prenotice is sent through a PDCCH in an on duration/active time of the UE; and after the D2D UE served by the eNB in the communication group all enters the DRX state, a multicast data packet is sent.

### INDUSTRIAL APPLICABILITY

According to the embodiment of the present disclosure, a manner that the D2D communication management entity sends the routing information used for D2D communication to the UE is adopted, so that the problem that there is no solution applicable to relay communication of D2D UE with other D2D UE in a routing information manner in the related technology is solved, and a solution to communication between the D2D UE based on the routing information is further provided.

Obviously, those skilled in the art should know that each component or step of the present disclosure may be implemented by a universal computing device, and the components or steps may be concentrated on a single computing device or distributed on a network formed by a plurality of computing devices, and may optionally be implemented by programmable codes executable for the computing devices, so that the components or steps may be stored in a storage device for execution with the computing devices, or may form each integrated circuit component respectively, or multiple components or steps therein can form a single integrated circuit component for implementation. As a consequence, the present disclosure is not limited to any specific hardware and software combination.

The above is only the preferred embodiment of the present disclosure and not intended to limit the present disclosure. For those skilled in the art, the present disclosure may have various modifications and variations. Any modifications, equivalent replacements, improvements and the like made within the principle of the present disclosure shall fall within the scope of protection of the present disclosure.

1. A method for sending routing information, comprising:
sending to User Equipment (UE), by a Device-to-Device (D2D) communication management entity, routing information used for D2D communication.

2. The method as claimed in claim 1, before sending, by the D2D communication management entity, the routing information to the UE, further comprising:
generating, by the D2D communication management entity, the routing information according to state information of the UE, wherein the state information is used for indicating a neighbouring relationship and/or link condition information between the UE and neighbouring UE.

3. (canceled)

4. The method as claimed in claim 1, wherein the UE comprises relay UE, wherein the relay UE is determined by the D2D communication management entity according to a capability of the UE and a position of the UE in a network topology connection relationship, and/or, is determined by information configured before communication; the relay UE is divided into following types: a first type of relay UE which is UE located on an edge in the network coverage and responsible for transmitting information in the network coverage to UE outside of network coverage, the information comprising control information and/or data information; and a second type of relay UE which is UE responsible for forwarding information when all UE is outside of network coverage, the information comprising control information and/or data information.

5. The method as claimed in claim 1, wherein the D2D communication management entity comprises one of:
an eNB, a Mobility Management Entity (MME), a Proximity Service (ProSe) server, a central control node, a group master in a D2D communication group and a cluster head.

6. The method as claimed in claim 2, under a condition that the UE under network coverage forwards data through an eNB, after generating, by the D2D communication management entity, the routing information, the method further comprising:
sending, by the D2D communication management entity, the routing information to the eNB.

7. The method as claimed in claim 1, further comprising: updating, by the D2D communication management entity, the routing information after receiving at least one of following updating information:
updating information, sent by the UE, about change of UE information;
updating information, sent by the UE, about change of a neighbouring relationship and/or link state information between UE;
updating information, sent by an Evolved Packet Core (EPC), about change of the neighbouring relationship between the UE;
updating information, sent by an eNB, about change of an air interface resource; and
updating information, sent by a Core Network (CN) where an eNB is located, about change of a backhaul resource load;
wherein the updating information is sent to the D2D communication management entity in an incremental manner or a complete manner.

8. (canceled)

9. The method as claimed in claim 7, wherein the updating information is periodically reported by at least one of the UE, the eNB and a location server of the EPC, and/or, is reported according to an indication of the D2D communication management entity.

10. The method as claimed in claim 7, under a condition that the UE is under network coverage and/or partially under the network coverage, the method further comprising: updating, by the D2D communication management entity, the routing information according to a routing strategy, wherein the routing strategy comprises at least one of:
cellular network communication preferred, D2D communication preferred and path condition sensing;
under a condition that all UE is outside of network coverage, the method further comprising: updating, by the D2D communication management entity, the routing information according to a routing strategy, wherein the routing strategy comprises: path condition sensing.

11. (canceled)

12. The method as claimed in claim 1, wherein the routing information comprises:
an Identity (ID) of a sending node of the UE and an ID of a next-hop node, wherein the next-hop node comprises UE and/or an eNB, the ID of the sending node of the UE comprises: a UE ID, and the ID of the next-hop node comprises: a UE ID and/or an eNB ID; the UE ID comprises: a mobile user ID, an Internet Protocol (IP) address, a logical username, a Temporary Mobile Subscriber Identity (TMSI), an International Mobile Subscriber Identity (IMSI), a Radio Network Temporary Identity (RNTI), or other ID used for UE identification; and the eNB ID comprises: a global eNB ID, a logical eNB name and/or an eNB label.

13. The method as claimed in claim 12, wherein the routing information further comprises at least one of:
network coverage condition information of the sending node of the UE and a communication mode between the sending node of the UE and the next-hop node.

14. The method as claimed in claim 2,
before generating, by D2D communication management entity, the routing information, the method further comprising: receiving, by the D2D communication management entity, the state information sent by the UE in one of following manners:
under a condition that the D2D communication management entity is an eNB, UE under network coverage sends the state information to the D2D communication management entity, and/or, the state information sent by UE outside of network coverage is forwarded to the D2D communication management entity through a first type of UE, which is under the network coverage, in the UE;
under a condition that the D2D communication management entity is an MME or a ProSe server, an eNB sends the state information sent by UE under network coverage to the D2D communication management entity, and/or, the eNB and a first type of relay UE, which is under the network coverage, in the UE forward the state information sent by UE outside of network coverage to the D2D communication management entity; and
under a condition that all UE is outside of network coverage, UE directly neighbouring to the D2D communication management entity among the UE sends the state information to the D2D communication management entity, and/or, a second type of relay UE in the UE forwards, to the D2D communication management entity, the state information sent by UE which is not directly neighbouring to the D2D communication management entity;
and/or,
before generating, by the D2D communication management entity, the routing information, the method further comprising:
receiving, by the D2D communication management entity, the state information of the UE from an EPC;
and/or,
before generating, by the D2D communication management entity, the routing information, the method further comprising:
acquiring, by the D2D communication management entity, information of multiple eNBs and state information of UE related to each eNB in the multiple eNBs, wherein the information of the multiple eNBs comprises: information of the multiple eNBs and their neighbouring eNBs and information of UE under network coverage of each eNB; the UE related to each eNB in the multiple eNBs comprises: the UE under the network coverage of each eNB, UE which is outside of network coverage but is reachable through forwarding of a first type of relay UE under the network coverage of each eNB;
wherein the D2D communication management entity generates the routing information according to the state information of the UE and the information of the multiple eNBs.

15. (canceled)

16. (canceled)

17. The method as claimed in claim 14, wherein, under a condition that the D2D communication management entity is an MME, one eNB in the multiple eNBs or a ProSe server, acquiring, by the D2D communication management entity, the state information of the UE and the information of the multiple eNBs comprises:
receiving, by each eNB in the multiple eNBs, the state information of the UE under respective network coverage, and/or, receiving, by each eNB in the multiple eNBs through a first type of relay UE under respective network coverage, the state information, which is forwarded by the first type of relay UE, of UE outside of network coverage, and sending, by each eNB in the multiple eNBs, the state information of each UE and the information of the multiple eNBs to the D2D communication management entity;
wherein under a condition that the D2D communication management entity is one eNB in the multiple eNBs, the D2D communication management entity receives the state information of the UE related to each eNB and the information of the other eNBs through X2 interfaces with the other eNBs in the multiple eNBs and/or an S1 interface between the eNB and a CN.

18. The method as claimed in claim 2, wherein, under a condition that the UE forwards data through an eNB, generating the routing information comprises:
establishing a network topology connection relationship between the UE and the eNB according to the state information of the UE and information of the eNB; and
generating the routing information according to the network topology connection relationship.

19. The method as claimed in claim 2, wherein, under a condition that all UE is outside of network coverage and/or eNBs do not participate in data forwarding, generating the routing information comprises:
establishing a network topology connection relationship among multiple pieces of UE according to the state information of the multiple pieces of UE; and
generating the routing information according to the network topology connection relationship.

20. The method as claimed in claim 2, wherein the state information of the UE is determined according to at least one of: feedback of the other UE about receiving conditions of discovery signals sent by the UE to the other UE in the UE, signals received by the UE from the other UE, and position information, acquired from the location server of the EPC, of the UE.

21. (canceled)

22. The method as claimed in claim 6, wherein a manner for the D2D communication management entity to send the routing information to the UE and/or the eNB comprises one of manners as follows:
under a condition that the D2D communication management entity is an eNB, the D2D communication management entity sends the routing information to UE under the network coverage and/or the eNB, and UE outside of network coverage acquires the routing information by forwarding of a first type of relay UE under the network coverage;
under a condition that the D2D communication management entity is an MME or a ProSe server, the D2D communication management entity sends the routing information to a serving eNB of the UE, then the serving eNB of the UE sends the routing information to the UE, and furthermore, a first type of relay UE in the UE forwards the routing information to UE outside of the network coverage; and
under a condition that all UE is outside of network coverage, the D2D communication management entity sends the routing information to UE directly neighbouring to the D2D communication management entity, and/or, the D2D communication management entity sends the routing information to the UE which is not directly neighbouring to the D2D communication management entity through a second type of relay UE in the UE.

23. The method as claimed in claim 2,
wherein the D2D communication management entity generates or updates the routing information according to a request of the UE and/or eNB, and/or, the D2D communication management entity actively generates or updates the routing information, wherein the D2D communication management entity sends the updated routing information to the UE and/or the eNB in an incremental notification manner or a complete notification manner.

24. (canceled)

25. The method as claimed in claim 1, under a condition that one piece of UE in the UE initiates D2D communication according to the received routing information, further comprising:
receiving, by the D2D communication management entity, a traffic starting indication sent by the UE initiating the D2D communication; and
updating routing information of a relay node related to D2D communication of the UE initiating the D2D communication according to the traffic starting indication, wherein the relay node comprises: relay UE in the UE and/or the eNB.

26. The method as claimed in claim 25, wherein
the traffic starting indication comprises: an address of a destination node of traffic; or,
the traffic starting indication comprises: the address of the destination node of the traffic and a duration of the traffic.

27. The method as claimed in claim 25, after updating the routing information of the relay node, further comprising:
receiving, by the D2D communication management entity, a traffic ending indication sent by the UE initiating the D2D communication; and
stopping sending, by the D2D communication management entity, the updated routing information to the relay node related to the D2D communication according to the traffic ending indication.

28. The method as claimed in claim 6, under a condition that one piece of UE in the UE needs to forward data through an eNB, after the eNB receives the data, the method further comprising:
judging, by the eNB, whether UE receiving the data is in a Discontinuous Reception (DRX) state or not; and
under a condition that a judgment result is that the UE receiving the data is in the DRX state, forwarding, by the eNB, a data packet to the UE receiving the data within a next on duration/active time of the UE receiving the data.

29. The method as claimed in claim 6, under a condition that at least one piece of UE in the UE sends a data packet to UE served by an eNB through the eNB, the method further comprising:
judging, by the eNB, whether there is UE in a DRX state among all UE under network coverage of the eNB or not;
under a condition that a judgment result is that there is UE in the DRX state, sending, by the eNB, a group communication prenotice through a Physical Downlink Control Channel (PDCCH) within an on duration/active time of the UE in the DRX state; and
under a condition that all UE served by the eNB enters a continuous reception state, sending, by the eNB, the data packet to the UE served by the eNB by group communication.

30. The method as claimed in claim 29, wherein the eNB configures a same DRX parameter to the UE under the network coverage of the eNB.

31. A method for receiving routing information, comprising:
receiving from a D2D communication management entity, by User Equipment (UE), routing information used for Device-to-Device (D2D) communication.

32. The method as claimed in claim 31, before receiving, by the UE, the routing information, further comprising:
acquiring, by the D2D communication management entity, state information of the UE from the UE and/or a location server of an Evolved Packet Core (EPC), wherein the state information is used for indicating a neighbouring relationship and/or link condition information between the UE and neighbouring UE, and the routing information is generated by the D2D communication management entity according to the state information.

33. The method as claimed in claim 31, after receiving, by UE, the routing information, further comprising:
performing, by the UE, D2D communication according to the routing information, wherein UE initiating communication judges whether D2D communication is able to be performed with corresponding UE or not according to the received routing information, and under a condition that a judgment result is that the D2D communication is able to be performed with the corresponding UE, the UE initiating communication initiates D2D communication to the corresponding UE, wherein the D2D communication comprises one of manners as follows: unicast communication, group communication and broadcast communication.

34. The method as claimed in claim 33, wherein, under a condition that the UE performs D2D communication according to the routing information and an address of a destination node of a data packet received by a first type of relay UE or a second type of relay UE in the UE is not an address of the first type of relay UE or the second type of relay UE, the first type of relay UE or the second type of relay UE forwards the data packet according to an Identity (ID) of a next-hop node and/or a communication mode between the first type of relay UE or the second type of relay UE and the next-hop node in the routing information.

35. The method as claimed in claim 34, wherein the communication mode is contained in the routing information, or, is determined according to the ID of the next-hop node, wherein a D2D communication manner is adopted when the next-hop node is UE, and a cellular communication manner is adopted when the next-hop node is an Evolved Node B (eNB).

36. The method as claimed in claim 31, under a condition that the number of pieces of UE neighbouring to the first type of relay UE or the second type of relay UE in the UE is more than or equal to 2, after receiving, by the first type of relay UE or the second type of relay UE, the routing information from the D2D communication management entity, the method further comprising:
receiving, by the first type of relay UE or the second type of relay UE, D2D communication forwarding table information sent by the D2D communication management entity, wherein the D2D communication forwarding table information is used for indicating processing of the first type of relay UE or the second type of relay UE over the received data packet in group communication and/or broadcast communication.

37. The method as claimed in claim 36, wherein, under a condition that the first type of relay UE or the second type of relay UE is not directly neighbouring to the D2D communication management entity, the first type of relay UE or the second type of relay UE receives the D2D communication forwarding table information through UE directly neighbouring to the D2D communication management entity and/or an eNB.

38. The method as claimed in claim 36, wherein the D2D communication forwarding table information comprises: a D2D communication address, a communication mode and a latest data packet index.

39. The method as claimed in claim 36, wherein the D2D communication forwarding table information is generated by the D2D communication management entity according to a preset strategy, wherein the preset strategy comprises at least one of: cellular communication preferred, D2D communication preferred and path condition sensing.

40. The method as claimed in claim 39, wherein the D2D communication forwarding table information generated according to the preset strategy of cellular communication preferred comprises: D2D communication forwarding table information used for local routing of an eNB, and/or, D2D communication forwarding table information used for routing through a Core Network (CN).

41. The method as claimed in claim 40, under a condition that the D2D communication forwarding table information comprises the D2D communication forwarding table information used for local routing of the eNB and the D2D communication forwarding table information used for routing through the CN, before group communication and/or broadcast communication of the first type of relay UE or the second type of relay UE, the method further comprising:
determining, by the first type of relay UE or the second type of relay UE, D2D communication forwarding table information used for group communication and/or broadcast communication according to path weights of the D2D communication forwarding table information used for local routing of the eNB and the D2D communication forwarding table information used for routing through the CN.

42. The method as claimed in claim 36, wherein, after the first type of relay UE or the second type of relay UE receives the D2D communication forwarding table information, processing, by the first type of relay UE or the second type of relay UE, the received data packet according to the D2D communication forwarding table information comprises:
judging, by the first type of relay UE or the second type of relay UE, whether the received data packet is consistent with a preset characteristic or not, wherein the preset characteristic comprises that: an address of the destination node of the data packet is a group communication/broadcast communication address, and an index of the data packet is a latest data packet index in the D2D communication forwarding table information or the index of the data packet has yet not appeared in the D2D communication forwarding table information;
under a condition that a judgment result indicates that the data packet is consistent with the preset characteristic, analyzing the received data packet; and
forwarding the received data packet according to a communication mode, indicated in the D2D communication forwarding table, between the first type of relay UE or the second type of relay UE and the destination node.

43. The method as claimed in claim 42, under a condition that the judgment result indicates that the data packet is inconsistent with the preset characteristic, processing, by the first type of relay UE or the second type of relay UE, the received data packet according to the D2D communication forwarding table information further comprises:
discarding, by the first type of relay UE or the second type of relay UE, the received data packet.

44. The method as claimed in claim 42, after forwarding, by the first type of relay UE or the second type of relay UE, the received data packet, the method further comprising:
updating, by the first type of relay UE or the second type of relay UE, the data packet index in the D2D communication forwarding table information.

45. The method as claimed in claim 34, under a condition that a UE communication node topology relationship changes, further comprising:
receiving, by the first type of relay UE or the second type of relay UE, updating information of the D2D communication forwarding table information from the D2D communication management entity.

46. The method as claimed in claim 45, wherein change of the UE communication node topology relationship comprises at least one of:
disappearance of a UE communication node and addition of a UE communication node.

47. The method as claimed in claim 31, wherein the routing information is sent by the D2D communication management entity according to a request of the UE, and/or, the routing information is actively sent by the D2D communication management entity.

48. A device for sending routing information, located in a Device-to-Device (D2D) communication management entity, comprising:
a first sending component, configured to send, to User Equipment (UE), routing information used for D2D communication.

49. A device for receiving routing information, located in User Equipment (UE) supporting Device-to-Device (D2D) communication, comprising:
a receiving component, configured to receive, from a D2D communication management entity, routing information used for D2D communication.

50. A system for processing routing information, comprising: a device for sending routing information which is located in Device-to-Device (D2D) communication management entity, and the device for receiving routing information which is located in User Equipment (UE) as claimed in claim 49, wherein the device for sending routing information comprises a first sending component, configured to send, to the UE, routing information used for D2D communication.
